(19) United States
(12) Patent Application Publication
(10) Pub. No.: US 2026/0094471 A1
(43) Pub. Date: Apr. 2, 2026

(54) SYSTEMS AND METHODS FOR MARKSMANSHIP DIGITIZING AND ANALYZING

(71) Applicant: ACCUSHOOT, INC., Corvallis, OR (US)

(72) Inventors: Rick Hangartner, Corvallis, OR (US); Francisco Martin, Corvallis, OR (US); Poul Petersen, Corvallis, OR (US); Ken Baldwin, Albany, OR (US); Jim Shur, Barcelona (ES); Segio de Simone, Barcelona (ES); Beatriz Garcia, Valencia (ES); Oscar Rovira, Valencia (ES); Pablo Gonzalez, Valencia (ES); Alvaro Clemente, Madrid (ES); Candido Zuriaga, Valencia (ES)

(21) Appl. No.: 19/111,287

(22) PCT Filed: Sep. 13, 2023
(86) PCT No.: PCT/US2023/032667

§ 371 Date: Mar. 12, 2025

Related U.S. Application Data
(60) Provisional application No. 63/406,241, filed on Sep. 13, 2022.

(51) Int. Cl. G06V 40/20; G06T 7/20; G06V 20/40; G06V 40/10

(52) U.S. Cl. CPC G06V 40/28; G06T 7/20; G06V 20/41; G06V 40/107; G06T 2207/20081

(57) ABSTRACT

A body movement improvement system is configured to receive video data, track one or more body landmarks associated with the movement to determine motion of the body landmarks during an action, correlate the motion of the body landmarks with a score of the action, and use machine learning techniques to determine the motion that is detrimental to the score of the action. The system can also recommend drills for the participant to improve the score of the action.

### CROSS-REFERENCE TO RELATED APPLICATIONS

This application claims the benefit of U.S. Provisional Ser. No. 63/406,241, filed Sep. 13, 2022, entitled “SYSTEMS AND METHODS FOR MARKSMANSHIP DIGITIZING AND ANALYZING,” the contents of which is incorporated herein by reference in its entirety.

### BACKGROUND

Target shooting is enjoyed by millions of people a year and according to many reports, the number of people who routinely target shoot has increased over the past ten years and is continuing to increase. In the US alone, it is estimated that over 52 million people routinely shoot at targets. There are many different types of recreational shooting activities, from simple plinking with handguns or rifles at paper or steel targets, to skilled long-range rifle shooting matches that require a high degree of discipline and skill, to fun and fast-paced shooting of pistols at popup or stationary targets or shotgun shooting at skeet, trap, sporting clays and more. Apart from recreational shooting, there is a growing number of target shooters that practice as part of their occupation, such as law enforcement, military, and security personnel.

While many of the participants are happy with their current skill level, there is a growing number of marksmen who desire to improve their skills. However, in some cases, many of the participants do not know how to improve. The growing number of people at shooting ranges continues to increase and these participants, whether there for sport, recreation, personal defense, or public defense, have a desire to improve their skills. However, without personalized shooting instruction, or oftentimes even with personalized instruction, it can be difficult to quantify improvements, and any issues that affect accuracy. Moreover, many participants do not know how to get better.

There is thus a need for a system and methods that can analyze a participant's habits and provide feedback and recommendations for improvement. There is a further need for a system that is capable of providing the aforementioned benefits using consumer-grade equipment, and in near-real time. These and other benefits will become readily apparent from the disclosure that follows.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for improving shooting performance. The method also includes receiving video data of a shooter; determining one or more body landmarks of the shooter, tracking the one or more body landmarks during a shot to generate shot motion data, determining a score of the shot, associating the shot motion data with the score, and generating recommendations for altering the motion data on a subsequent shot. Other embodiments of this aspect include corresponding computer systems, apparatus, and computer programs recorded on one or more computer storage devices, each configured to perform the actions of the methods.

Implementations may include one or more of the following features. The method where determining one or more body landmarks of the shooter may include generating a wire frame model by connecting the body landmarks. Associating the shot motion data with the score may include executing a classification and regression tree machine learning model to identify causal relationship between the shot motion data and the score. The method may include determining, through image analysis of the video data of the shooter, a grip of the shooter. The method may include analyzing the grip of the shooter and providing, on a display screen, grip recommendations to alter the grip. Determining the score of the shot may include: receiving target video data; performing image analysis on the received target video data; determining a hit on the target; and determining a score of the hit. Receiving the video data includes capturing video data by a mobile phone. Determining one or more body landmarks includes determining 17 body landmarks. Tracking the one or more body landmarks includes generating a bounding box around each of the one or more body landmarks. The method may include executing a machine learning model to correlate the shot motion data with the score. The machine learning model is configured to determine the motion data that results in an off-center target hit. Implementations of the described techniques may include hardware, a method or process, or computer software on a computer-accessible medium.

One general aspect includes a method for improving a causal consequence of body movement. The method also includes receiving video data of a body motion; determining one or more body landmarks viewable in the video data of the body motion; tracking the one or more body landmarks during an action; generating, based at least in part on the tracking the one or more body landmarks, motion data; determining a score associated with the motion data; associating the motion data with the score; and generating recommendations for altering the motion data on a subsequent action. Other embodiments of this aspect include corresponding computer systems, apparatus, and computer programs recorded on one or more computer storage devices, each configured to perform the actions of the methods.

Implementations may include one or more of the following features. The method where receiving the video data includes capturing the video data by a mobile computing device. The method may include executing a machine learning model to correlate the motion data with the score. The machine learning model is configured to determine the motion data that results in a reduced score. The method may include predicting, by the machine learning model, a predicted score based on the motion data. The method may include comparing the predicted score with the score. Implementations of the described techniques may include hardware, a method or process, or computer software on a computer-accessible medium.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1A illustrates an image of a shooter captured by an image capture device, in accordance with some embodiments.

FIG. 1B illustrates a wire frame model of the shooter from FIG. 1A, in accordance with some embodiments.

FIG. 2 illustrates motion data associated with a plurality of body landmarks, in accordance with some embodiments.

FIG. 3 illustrates motion data associated with a plurality of body landmarks, and automatic shot detection based on the motion data, in accordance with some embodiments.

FIG. 4 illustrates analysis of motion data associated with a plurality of body landmarks and identifying shooting errors based on the motion data, in accordance with some embodiments.

FIG. 5 illustrates analysis of motion data associated with a plurality of body landmarks and identifying shooting errors based on the motion data, in accordance with some embodiments.

FIG. 6 illustrates analysis of motion data associated with a plurality of body landmarks, in accordance with some embodiments.

FIG. 7 illustrates analysis of motion data associated with a plurality of body landmarks and identifying a change in pose that least to improvements in performance, in accordance with some embodiments.

FIG. 8A illustrates an image of a shooter taken with an imaging device, in accordance with some embodiments.

FIG. 8B illustrates a computer-generated wire frame model of the shooter of FIG. 8A with identified body landmarks, in accordance with some embodiments.

FIG. 9 illustrates motion data associated with a plurality of body landmarks and identifying body motion leading to reduced performance, in accordance with some embodiments.

FIGS. 10A and 10B illustrate diagnostic targets that identify shooter behaviors based on shot patterns, in accordance with some embodiments.

FIG. 11 illustrates an image of a shooter's hand and a computer-generated wire frame model associated with body landmarks that identify and analyze a shooter's grip, in accordance with some embodiments.

FIG. 12A is an illustration of a computer software program user interface that captures video images, tracks motion of body landmarks, and analyzes a shooter's pose and motion data, in accordance with some embodiments.

FIG. 12B is an illustration of a computer software program user interface that analyzes a shooter's performance and automatically scores the performance, in accordance with some embodiments.

FIGS. 13A and 13B illustrate a system for marksmanship digitizing and analyzing, in accordance with some embodiments.

FIG. 13C illustrates a system for marksmanship digitizing and analyzing, in accordance with some embodiments.

FIG. 14 illustrates a system for marksmanship digitizing and analyzing, in accordance with some embodiments.

FIG. 15 illustrates the logic of a machine learning algorithm to quantify shot samples, in accordance with some embodiments.

FIG. 16 illustrates a sample decision tree machine learning model that correlates motion data of body landmarks with shot performance, in accordance with some embodiments.

FIG. 17 illustrates an annotated decision tree machine learning model that correlates motion data of body landmarks with shot performance, in accordance with some embodiments.

FIG. 18 illustrates a pruned decision tree machine learning model that correlates motion data of body landmarks with shot performance, in accordance with some embodiments.

FIG. 19A illustrates a system for capturing video data of a shooter and a target, in accordance with some embodiments.

FIGS. 19B and 19C illustrate image data of a left-hand view and a right-hand view of a shooter captured by imaging devices, in accordance with some embodiments.

FIG. 19D illustrates image data of an overhead view of a shooter captured by an imaging device, in accordance with some embodiments.

FIG. 19E illustrates image data of a target captured by an imaging device, in accordance with some embodiments.

FIG. 20 illustrates a sample user interface of a computer application configured to receive, analyze, and score marksmanship performance, in accordance with some embodiments.

FIG. 21 illustrates a sample user interface of a computer application configured to receive, analyze, and score marksmanship performance showing shot placement, and automated scoring, in accordance with some embodiments.

FIG. 22 illustrates a sample user interface of a computer application configured to receive, analyze, and score marksmanship performance allowing a selection of body landmarks and showing the motion data associated with the selected body landmarks, in accordance with some embodiments.

FIG. 23 illustrates several of the key technologies enabled in embodiments described herein along with the features the key technologies facilitate, in accordance with some embodiments.

FIG. 24 illustrates a system that uses multiple source collaboration and machine learning to detect shots fired, analyze shooting position and provide recommendations for improvement, and analyze grip position and provide recommendations for improvement, a sample user interface of a computer application configured to receive, analyze, and score marksmanship performance, in accordance with some embodiments.

FIG. 25 is a process flow for capturing motion data, analyzing the motion data, and generating recommendations for improvement, in accordance with some embodiments.

### DETAILED DESCRIPTION

According to some embodiments, a system is described that uses computer vision and machine learning to significantly reduce the manual and laborious nature of current training technologies, thus providing a continuously learning and adapting system. According to some embodiments, the system includes a machine vision and machine learning system that can track and estimate the pose of a participant, and determine positive and negative factors impacting the quality of the participation, such as pose, motion, anticipation, recoil, grip, stance, among other things. This may be performed, in large part, by a computer vision system that can track several body landmarks simultaneously, and in some cases, associate the motion of one or more body landmarks with marksmanship accuracy. As an example, a system may identify and track any number of body landmarks, such as 3, or 5, or 11, or 17, or 21, or 25, or 30, or more body landmarks. As the system tracks the position of the landmarks, which may be in two dimensions, or in three dimensions, the system can associate motion of the landmarks with rounds sent down range and scoring of individual rounds. The detection of rounds sent down range may be determined by motion one or more suitable markers, such as motion of the participants hand or wrist (or other body marker) in response to recoil, a sound of the firearm, a pressure wave associated with the muzzle blast, a target hit, or some other marker.

The system may further monitor the participant from one, two, three, or more perspectives and analyze the movement of each body landmark, and may further monitor shot accuracy and correlate the body landmark motion with accuracy. Based on the accuracy, the system may further provide an analysis of the body motion that causes less than perfect accuracy and may further suggest ways to ameliorate the body motion to improve accuracy.

The motion capture may be performed by one or more cameras aimed generally at the participant, and one or more cameras aimed at a target. In some cases, one or more of the cameras are associated with a mobile computing device, such as, for example, a smartphone, a tablet, a laptop, a digital personal assistant, and a wearable device (e.g., watch, glasses, body cam, smart hat, etc.). In some cases, a wearable device may include a sensor, such as an accelerometer, a vibration sensor, a motion sensor, or other sensor to provide motion data to the system. In some embodiments, the system tracks body marker position over time and generates motion plots.

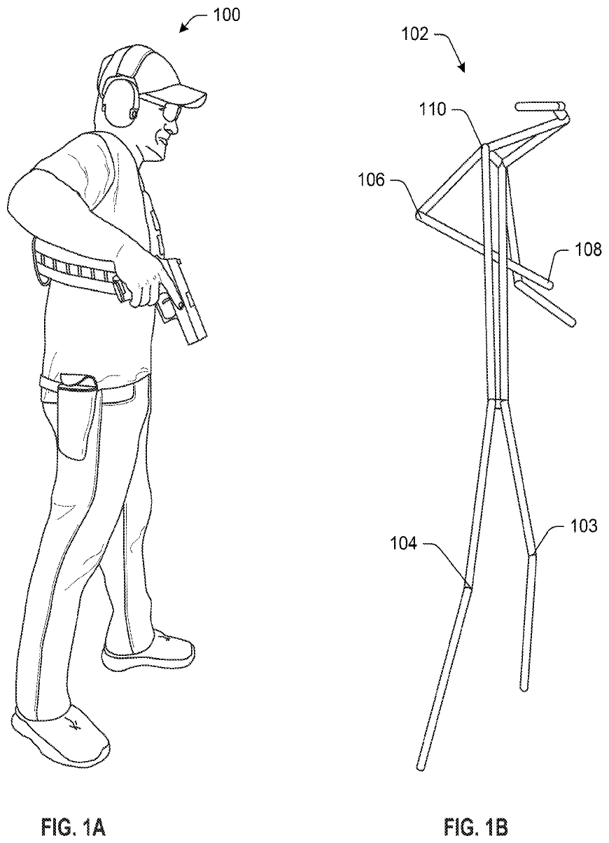

With reference to FIG. 1A, one or more cameras may capture one or more views of a shooter 100. The camera may capture video data of the shooter as the shooter draws, takes aim, fires a shot, reloads, and/or adjusts position. A computer system may receive the video data, analyze the video data, and create a model associate with the shooter as in FIG. 1B. In some cases, the computer system identifies body landmarks, and connects the body landmarks into a wire frame model 102 that tracks the pose and movements of the body landmarks of the shooter. In some instances, the body landmarks may include one or more of nose, left ear, left eye, left hip, left knee 103, right ear, right eye, right hip, left ankle, left elbow, left wrist, right knee 104, right ankle, right elbow 106, right wrist 108, left shoulder, and right shoulder 110. Of course, other body landmarks are possible, but for the sake of efficiency throughout this disclosure, we will focus on these seventeen body landmarks. In some embodiments, a single camera may capture two-dimensional motion data associated with one or more of the body landmarks. In some examples, two or more cameras may be used to capture three-dimensional motion data of one or more of the body landmarks.

The body landmarks may be tracked over time, such as during a shooting string (e.g., a shooting session) and the motion of one or more of the body landmarks may be tracked during this time. In some cases, two-dimensional motion is tracked in x and y directions corresponding with side-to-side movement and vertical movement. In some cases, three-dimensional movement of the body landmarks is tracked in x, y, and z directions.

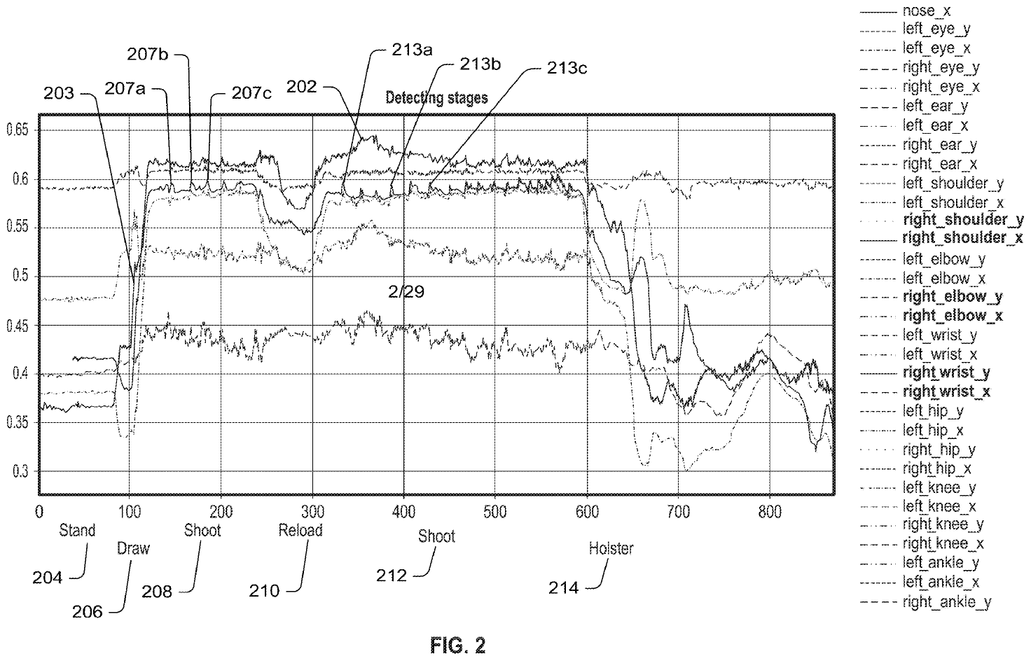

With reference to FIG. 2, a graph of selected body landmarks 200 is illustrated. The body landmarks can be user selectable by the user to focus on individual or combinations of body landmarks for review. For instance, the topmost line 202 represents the right wrist of a right-handed shooter in a horizontal direction, while the third line down 203 represents the right wrist vertical direction over time. As can be seen, the movement of the wrist moves up and down during the course of the motion capture. In some cases, the system may correlate the motion of the one or more body landmarks with events or stages, during the shooting string.

For instance, during the first stage 204, the right wrist is relatively low, and the system may correlate this position and movement with getting ready to begin. The second stage 206 which shows the right wrist moving upwardly over a very short interval may be correlated with drawing a pistol from a holster. The third stage 208 shows the right wrist remaining largely stable in the vertical plane; however, there are sharp peaks to the movement, 207a-207c which may be correlated with shots fired from the pistol.

During the fourth stage, 210, the right wrist moves downwardly and the returns to the firing position. The system may correlate this motion with a reloading operation. In some cases, the system is trained on training data, which may be supervised learning, to correlate similar motion with the various stages.

During the fifth stage, 212, the shooter's right wrist initially moves upwardly as the shooter takes aim, and then settles down onto the target, which is followed by peaks in the movement 213a-213c, which may be correlated with shots being fired down range.

In the sixth stage, 214, the right wrist moves downwardly again to an initial position, which may be correlated with holstering the pistol.

While the example focused on the shooter's right wrist in a vertical direction, it should be apparent that any of the body landmarks can be viewed, analyzed, and the motion or combinations of motion can be correlated with events or actions by the shooter, including groups of body landmarks.

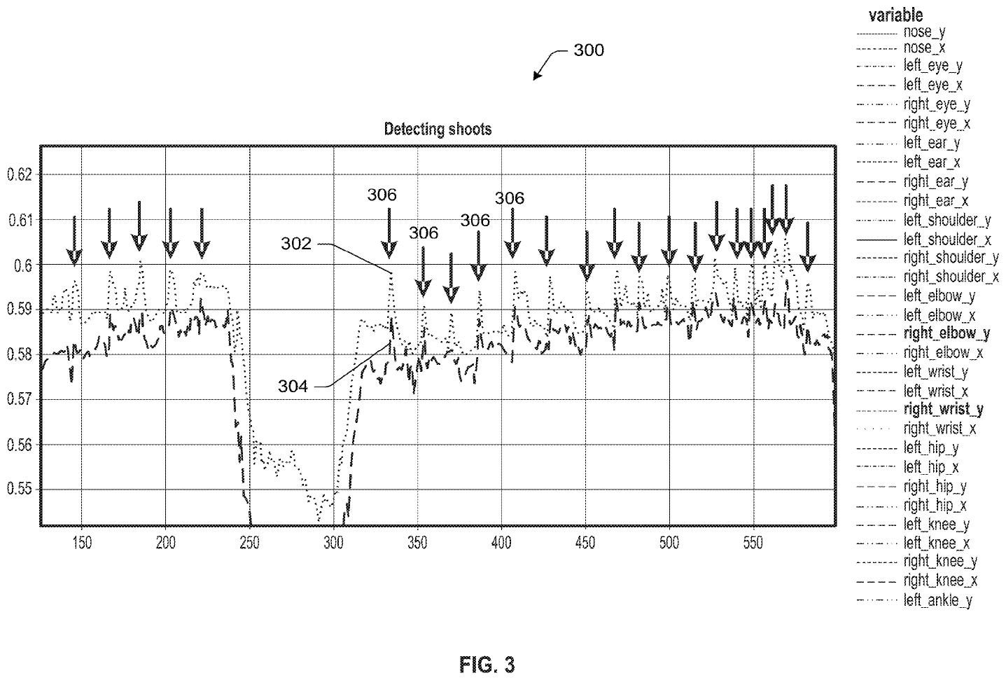

With reference to FIG. 3, a closeup view of the shooting stage 300 is depicted illustrating the sharp peaks in the right wrist movement 302 and right elbow movement 304 in the vertical direction. The system can analyze the motion data and automatically determine when a shot has been fired. The system can be configured to correlate the sharp peaks in vertical motion of the wrist and/or elbow with the shots fired. As shown in FIG. 3, each of the arrows 306 may coincide with a shot being fired. In addition, audio data may be correlated with the motion data to provide additional cues as to when a shot is fired. In some cases, the audio data may be combined and/or synched with the motion data to provide additional details about a shot being fired. The motion data may be used to infer additional information regarding the shooter, his habits, his posture, and other cues that may be brought to the attention of the shooter in an effort to improve the shooter's accuracy.

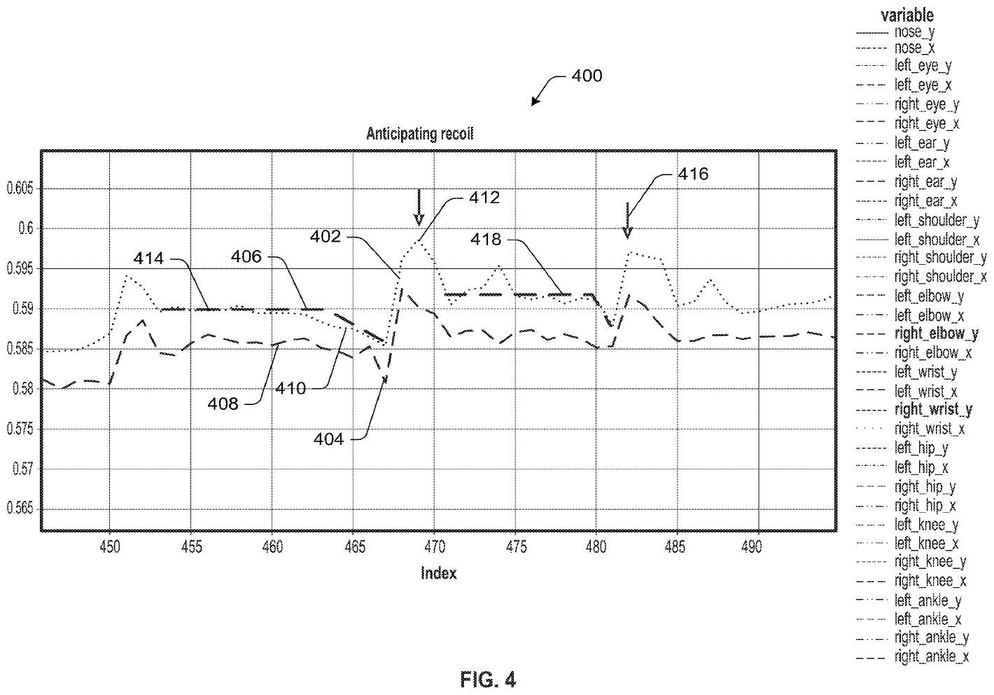

With reference to FIG. 4, motion data 400 is displayed for the right wrist 402 and right elbow 404 of a shooter. In some cases, the system may apply a trend curve 406 to the motion data that may represent normalized motion data. In addition, the system may make inferences and/or determinations based on the motion data 400. For example, as shown in FIG. 4, once a shooter places the firearm on target and attempts to hold the firearm steady, at 708, the shooter will lower the wrist and elbow, at 410, immediately followed by a shot fired 712. They system may recognize this pattern and determine that the motion of lowering the wrist and/or elbow immediately before a shot is evidence of the shooter trying to anticipate the recoil of the firearm and attempting to brace against it. In many cases, anticipating the recoil dramatically reduces the accuracy of the shot since the shooter is moving the firearm off target in anticipation of the recoil that happens as the shot is fired. Similar examples of motion data that may reduce the shooter's accuracy include flinch, pre-ignition push, trigger jerk, closing of the eyes, among others.

In some cases, the system may provide information to the shooter regarding the recoil anticipation and provide information, which may include one or more drills or practice sessions, in an effort to improve the shooter's motion data relating to recoil anticipation. For example, the system may identify a practice regimen that may include dry firing, skip loading (e.g., mixing live rounds in a magazine of dummy rounds), or other skill building drills.

FIG. 4 also shows that the shooter is experiencing drift in the posture. For instance, before the first shot 412, the shooters right wrist and right arm are position at a first vertical height 414, and before the second shot 416, the shooters right wrist and right elbow are positioned at a second vertical height 418 higher than the first vertical height. This data shows that the shooter did not return to the same position from the first shot to the second shot, and as a consequence, the shooter's sight picture will be slightly different which may reduce the accuracy of sequential shots.

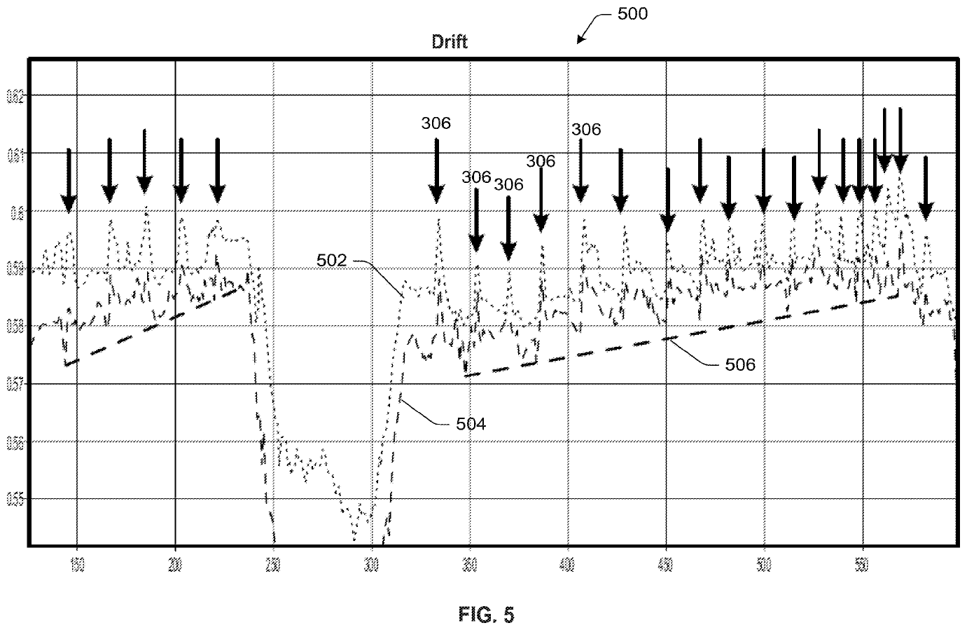

With reference to FIG. 5, drift is further demonstrated by the motion data 500. Motion data associated with a right-handed shooter's right wrist 502 and right elbow 504 shows not only recoil anticipation where the motion data shows a lowering of the body parts right before a shot, but also shows a trend line 506 that evidences that the shooter's wrist and elbow continually drift upwardly during a shooting string. The failure of the shooter to return to the same position in between shots can dramatically reduce the accuracy and precision of the shots fired within the string.

In some cases, the system will recognize the drift in one or more of the body landmarks and may provide this information to the shooter. In some cases, the system will provide information on a display screen associated with a mobile computing device. For example, the system may be implemented on a mobile computing device associated with a shooter, and a display screen on the mobile computing device may provide information, instructions, or practice drills to the shooter to improve the drift and the accuracy issues resulting therefrom.

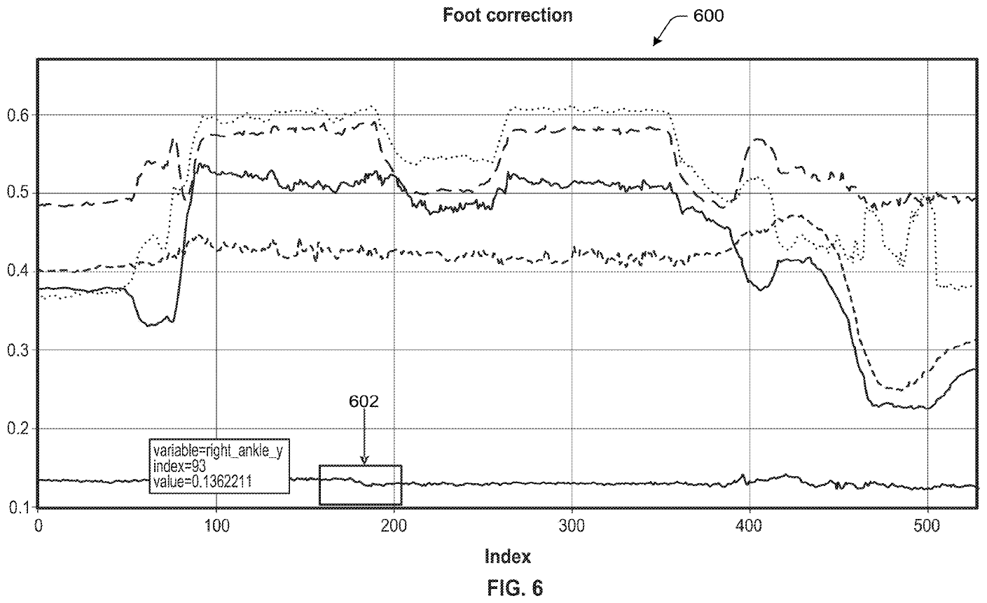

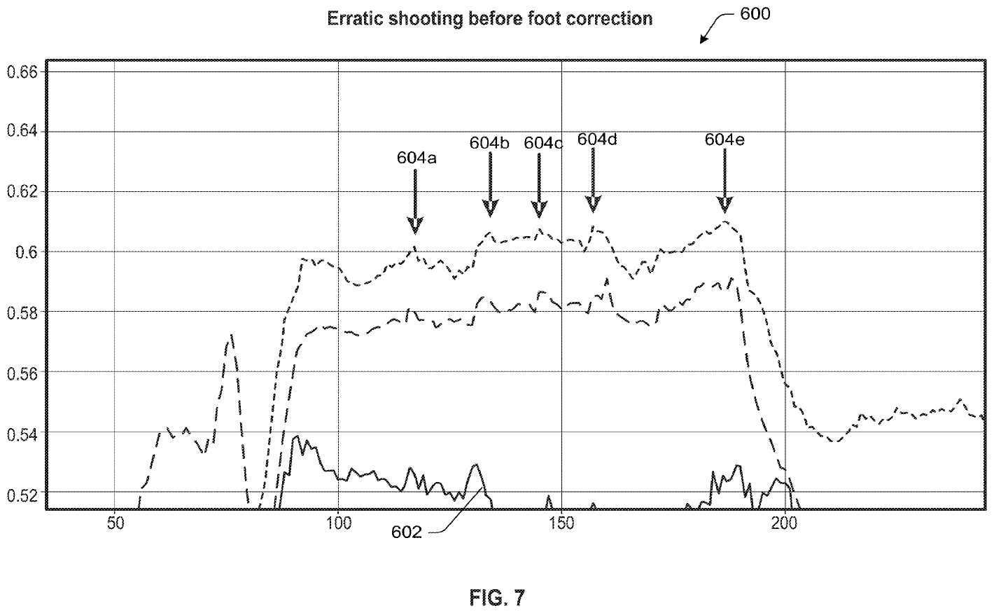

Similarly, the system may correlate body landmark motion with other correctable defects in the shooter's position or posture. For instance, with references to FIGS. 6 and 7, which show motion data 600 of body landmarks, motion data 600 shows the motion of a plurality of body landmarks during a shooting string. The lowermost line graph depicts right ankle motion data 602 that evidences that the shooter changed a position of the right foot. Changing positions during a shooting string is likely to affect the sight picture, accuracy, precision, and other metrics associated with shooting. The system may determine that the change in foot position was either positive or negative in terms of shot scoring and may provide recommendations to the shooter based on this change in posture. The system may view the shooting accuracy and/or precision of the shots fired 604a-604e both before and after the relocation of the foot and determine whether moving the foot had a positive or negative impact on the shooting performance.

In some cases, the system will correlate a scoring of the target (e.g., shot accuracy and/or precision) with body landmarks and motion and can indicate to the shooter which positions of individual body landmarks affected their shooting performance, either for the better or for the worse.

The system can be configured, through machine learning, to associate certain poses, motions, and combinations with shooting performance. In some cases, the body landmark motion and combinations of motions may be associated with improved shooting performance while others may be associated with decreased shooting performance.

The system may normalize the motion data to generate normalized coordinates of the position of each body part during all the session. The score and its moving average may be represented by a signal, such as by displaying it in a user interface. The motion data and/or the score may be stored in a data file that can be analyzed in either near-real time, or saved for later analysis.

The motion data may be associated with shot pattern data, such as the x and y coordinate of each shot and the shot coordinates may be associated in time with the motion data occurring at the time the shot was fired. Additionally, a score may be assigned to the shot and saved with the shot data.

One or more machine learning approaches may be applied to the motion data and shot data to generate correlations between the motion and shot accuracy. For example, in some embodiments, convolutional deep neural networks (CNN) may be designed to location features in a collection of motion and shot data. Other deep-learning models that are oriented toward classification may also be used to correlate the motion data and shot data to identify patterns that lead to an increase in accuracy or a decrease in accuracy. Transformations that correlate arbitrary collections of attributes with other arbitrary collections of attributes might also be used.

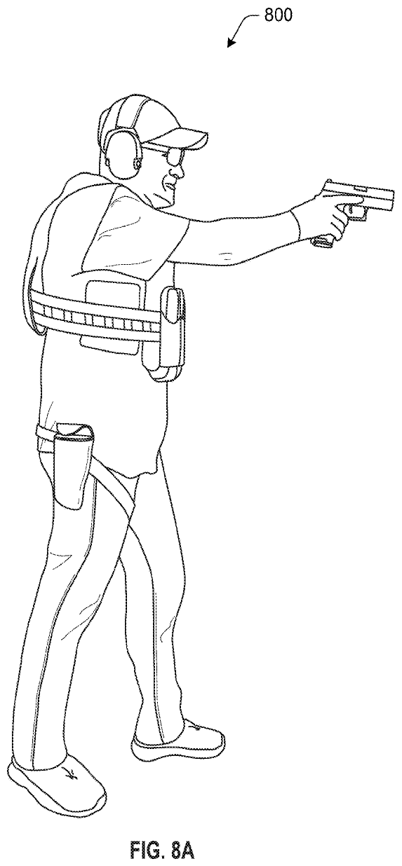

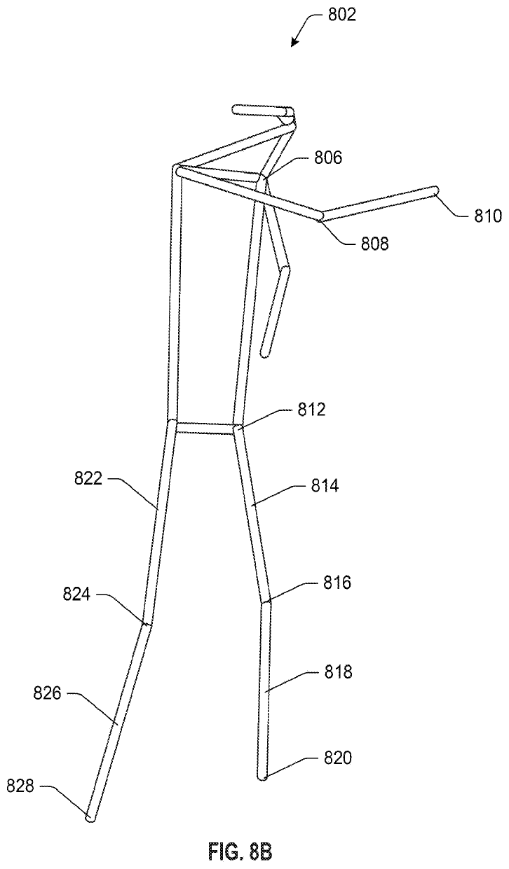

FIG. 8A illustrates a sample camera angle of a shooter 800 and FIG. 8B illustrates a resulting wire frame model 802 of the shooter that allows the system to track motion of the shooter's body including the selected body landmarks. As can be seen, the system is able to determine a shooter's pose, stance, and motion throughout a shooting string. The wire frame model may include representations of each major joint and body artifact which may include one or more of a shooter's nose or chin 804, right shoulder 806, right elbow 808, right wrist 810, hips 812, left femur 814, left knee 816, left lower leg 818, left ankle 820, right femur 822, right knee 824, right lower leg 826, and right ankle 828, among others. In some cases, the system may be trained on motion data from a variety of shooters and historical performance of those shooters correlated with the motion data. In this case, the system can determine the impact that specific poses and/or motions have on the shooting performance. In some cases, the system may rely on motion data from a single shooter to aid that shooter in making adjustments and/or further training exercises to improve the shooter's performance.

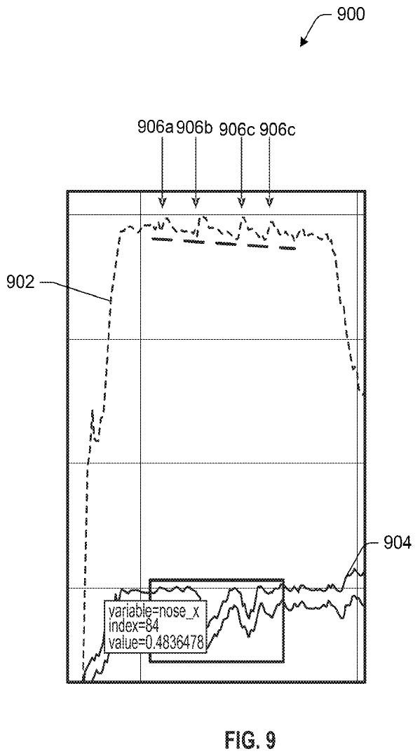

FIG. 9 illustrates x-axis motion data 900 associated with a shooters head 902 and nose 904. As can be seen, during a shooting string, after each shot 906a-906d, the shooter's head moved back, which may be correlated with a shooting performance. That is, the system may determine that the shooter's head moved after each shot, such as to look at the target, and may additional have drifted and not returned to the exact same spot during the shooting string which caused the shooter to perform below a threshold value.

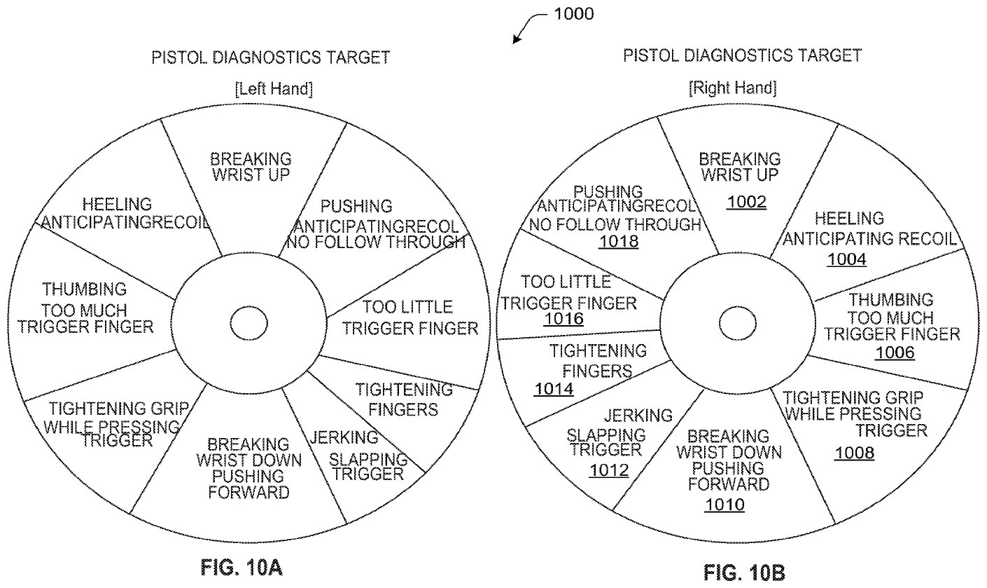

In some cases, the system may be configured with logic that determines a likely cause and effect based upon either the shooter's motions and/or the scoring of the target. With references to FIGS. 10A and 10B, which show a diagnostic target for a left-handed shooter, and a right-handed shooter 1000, respectively. The right and left-handed targets are mirror images of each other, so only one target will be described hereinbelow.

Assuming that a shooter is able to hold the pistol on target, motion associated with the shooter may be responsible for off-center hits. Where the off-center hits are regularly grouped on one side of the target, there are some likely issues that may be causing the off-center hits. For example, if a grouping of shots lands in the 12:00 position, the system may determine that the shooter is breaking his wrists up 1002 (e.g., riding the recoil), which often happens in anticipation of a recoil.

If a grouping of shots lands in the 1:30 position 1004, this may be indicative of the grip error known as heeling in which the heel of the hand pushes the butt of the pistol to the left in anticipation of the shot which forces the muzzle to the right.

If a grouping of shots lands in the 3:00 position 1006, which is indicative of the thumb of the shooting hand applying too much pressure and pushes the side of the pistol to the right which forces the muzzle to the right.

Where a group of shots lands in the 4:30 position 1008, this may be indicative of a shooter tightening the grip while shooting (e.g., lobstering). As the trigger is pulled it causes the front sight to dip which pushes the shots low and to the right for a right-handed shooter.

When a group of shots lands in the 6:00 position 1010, this may be indicative of breaking the wrist downwardly and pushing forward. This is often an unconscious effort to control the recoil and prevent the muzzle from lifting.

Where a group of shots lands in the 7:00 position 1012, this may be indicative of jerking or slapping the trigger. This may be indicative of a shooter trying to pull the trigger the instant the sights align with the target.

When a group of shots lands in the 8:00 position 1014, this may be indicative of the shooter tightening their grip during a shot.

Where a group of shots lands in the 9:00 position 1016, this may indicate too little finger on the trigger. This typically causes the shooter to squeeze the trigger at an angle during the final rearward movement of the trigger which has a tendency to push the muzzle to the left.

Where a group of shots lands in the 10:30 position 1018, this may indicate that the shooter is pushing in anticipation of the recoil with insufficient follow through.

The system may be programmed to view target hits during a shooting string, and in combination with the body landmark motion, determine whether the shooter is guilty of recoil anticipation, trigger control errors, and/or grip errors. The system can make this determination for individual shooters and can recommend practice exercises and practice strings for addressing the specific shooting issues.

In some cases, the system can access data on previous engagements (DOPE) associated with a shooter, which may include previous shooting sessions, records, scores, and analysis.

Along with real-time scoring, complete shooting sessions can be recorded and stored so that users can review them along with determination from the machine learning system that identifies and/or highlights deficiencies, mistakes, and changes in the shooters posture or technique that improve or reduce the shooter's performance.

Synergies come from the synchronization of all the available sources of information as described herein.

With continued reference to FIGS. 10A and 10B in which a diagnostic target is illustrated, the basic conventional ML model may map the target shot pattern φ∈Φ into a shooter behavior β∈B, f_{T}Φ→B. The behavior may be a four-dimensional (4D) phenomenon that includes three-dimensional (3D) motion data plus time. The shot pattern Φ is a two-dimensional (2D) projection of an evolving 3-D phenomenon (2D plus time). This model may be founded on causal hypotheses.

An expert may look at a much larger collection of complex shooter behavior B*⊃B and map that into a larger collection of shot patterns Φ*, f_{XP}: B*→Φ. The behavior β∈B* may be a 4D phenomenon and the shot pattern φ∈Φ* is a 2D phenomenon. One may speculate this is a causal model in principle because the expert conforms the model according to his or her understanding of a shooter's physiological kinematics and psychology and to the physics of shooting.

A relatively simple iterative model for expert leaning may include predicting the shot pattern from observed shooter behavior: f_{XP}: B*→Φ. The model may then assess the difference between the predicted shot pattern and the actual shot pattern: δ(φ′, φ). The model may then adapt the causally informed prediction model f_{XP} based on the difference δ(φ′, φ). This may be repeated for each n-shot drill.

This type of learning model treats the shooter behavior β∈B* as a 3D phenomenon and the shot pattern φ∈Φ* as a 2D phenomenon. In some cases, the model is enhanced that treat B* as a 4D phenomenon, Φ* as a 3D phenomenon, or both. According to some embodiments, a pose analysis method represents the 4D shooter behavior B* by a 3D projection of B* (2D plus time).

The model can objectively identify good shot patterns (e.g., tightly grouped around the bullseye) from the rest of the “not good” shot patterns, by executing a decision function f_{G}: Φ→D, where Dis a binary variable. The model may also be configured to relate shooter behavior E* to how (why) shot patterns φ are “not good”.

In some embodiments, the sampled time signals for shooter behavior may be reduced for a single drill as a single line in a dataset. A bounding box may be derived around the set of X-Y coordinates of each of the body landmarks in a drill. The bounding boxes may be denoted as the shooter behaviors B. Thus, there may be a shooter behavior for each one of the body landmarks during a time period. In some cases, the shooter behaviors Band shot patterns Φ are represented in polar coordinates as a radius and angle. The shooter behaviors B (which in some examples is 17) are 2D having an (x,y) coordinate, or an (r,θ) representation. The shot pattern φ∈Φ is a causal consequence of shooter behavior β∈B, the method can treat the shot patterns Φ as proxies for the unobservable third dimension of the shooter behaviors B. The method may treat the shooter behaviors β∈B and shot patterns φ∈Φ as features and scores s∈S as the target for an ML model f_{ML}: B×Φ→S.

The model can be analyzed for patterns (β, φ, s)∈Ψ_{L}, Ψ_{H} resulting in low and high scores. Implicit or explicit clustering techniques might be used for this. In some cases, models f_{ML}: B×Φ→S can be built for multiple drills for a specific shooter and for drills for multiple shooters. In some cases, given a particular drill (β, φ, s) and model f_{ML}: B×Φ→S, the model quality can be assessed by comparing the actual score s∈S and predicted score s′∈S. Some models could be sequentially updated from these comparisons.

In some embodiments, low scoring drills (β, φ, s) can be assessed against Y to determine which of the 17 components of the observable shooter behavior β and the shot pattern φ as the proxy for unobservable shooter behavior are likely causes for the low score. This may be easiest for explainable models. Unobservable behaviors may be described by the usual labels in diagnostic targets like those above. In some instances, a shooter diagnostic application can also differentiate low scores due to sighting misalignment, perhaps easiest to understand as shots tightly grouped around a centroid other than the target bullseye. In some cases, the system determines that a reduced score has been obtained and generates recommendations for improving the score. As used herein, the term “reduced score” is used to mean a score that is less than a target score. The target score may be a perfect score, a participant's highest historical score, a participant's average score, or some other metric. For example, in a shooting event, the highest score for a given shot is oftentimes a “10.” In this case, a reduced score is any score lower than a “10.” Similarly, in other sports, a score may be assigned that is less than a desired score, such as, for example, a penalty kick in soccer may be a binary outcome with a miss being a reduced score as compared to a goal being scored. In reference to a golf shot, a golfer may, on average, hit their drive 275 yards. A reduced score may result from a drive carrying 250 yards, which is below the golfer's average drive distance, and the system may observe behavior and determine which behavior(s) resulted in the reduced score.

According to some embodiments, the system relies on artificial intelligence (AI) and/or machine learning (ML) for two determinations: detecting shooter movements and shot placement and analyzing shooter behaviors for how they result in shot placement. Having described detecting movements, there are multiple ways of analyzing how shooter behaviors result in shot placement. Firstly, an expert-based approach utilizes comparing an individual shooter's behavior for each drill to an expert's assessment of what should result in a good shot. Secondly, a data-based approach is conducted by building models from repetitions of the shooting behavior (“drill”) by a single shooter or multiple shooters. This may be considered an AI/ML-based discovery strategy, that determines what behaviors are correlated with good shots.

In some cases, AI/ML may be used to automate and enhance expert-based analysis in the sense that if prototypical “ideal” behaviors are known a priori, models for these a priori known behaviors could be fitted to the data for a single shooter or multiple shooters.

From that perspective, a transformer ML model may be mimic automated and enhanced expert-based analyses by combining a pre-trained data-based model for inferred relationships between language fragments (analogous to inferring relationships between shooter behaviors and shot placement) with additional stages of data-based adaption.

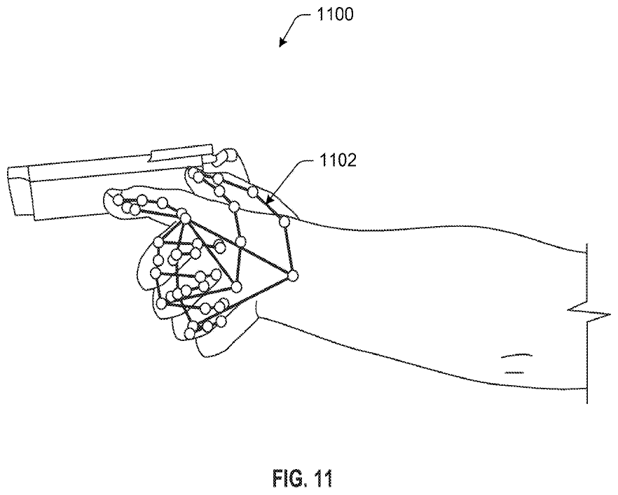

With reference to FIG. 11, the system determines key points for a shooter's hands 1100. Key points may coincide with each moveable joint of the wrist, hand, and fingers and their respective locations and position relative to each other. The system may connect the key points into a wire frame model 1102 of the shooter's hand, which allows precise monitoring of pose and motion. FIG. 11 illustrates a plurality of key points associated with a shooter's hand which may be used to determine the grip that the shooter is using. For example, by referring to the key points of a shooter's hand, the system may determine that the shooter is using a thumbs forward, thumb over, cup and saucer, wrist grip, trigger guard gamer, or another style grip. Different grips and pressure applied by the hands can impart motion to the pistol and the system may determine that a different, or modified, grip would result in better performance.

The system receives signals associated with the position and motion of the shooter and processes the signals to find mistakes in shooter stance and grip. In addition, by combining single frame analysis (e.g., finding insights from the relative positions between different body parts at a specific moment in time, which an analysis across time), it is possible to identify mistakes due to changes in the shooter's position.

In addition, the system can focus on the position of the hands on the pistol. A hand tracking machine learning model can be used to track the position of each bone in each finger in a video frame. The system will receive signals associated with the position of each finger across time.

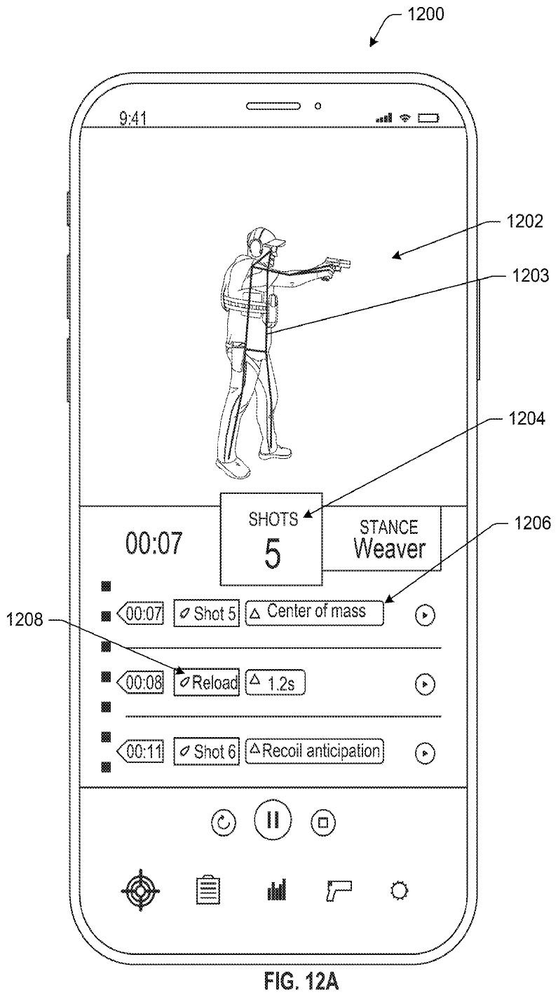

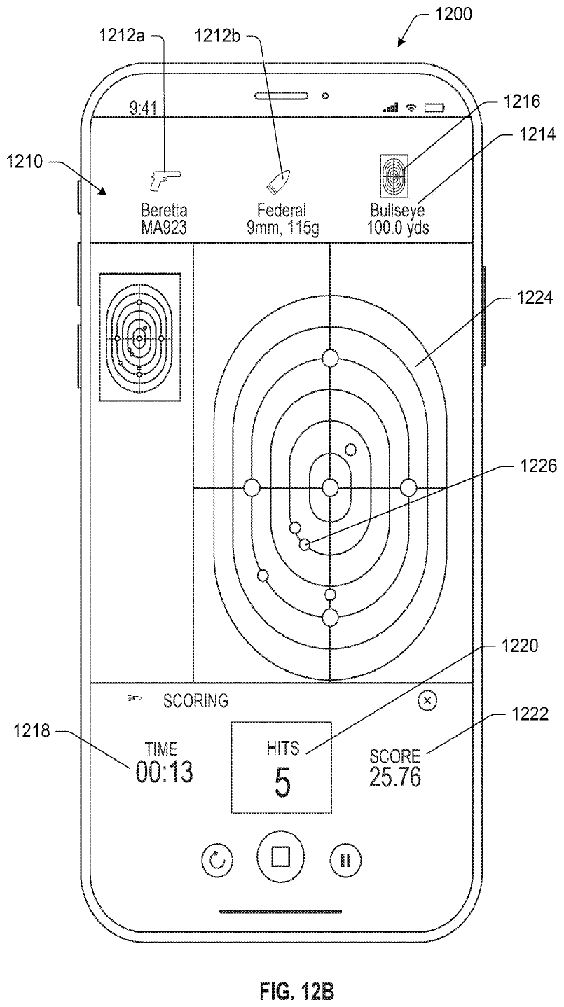

With reference to FIGS. 12A and 12B, an application program is shown that may be executed on a mobile computing device and receive image data from one or more imaging sensors associated with the mobile computing device. As with any of the embodiments described herein, the methods and processes can be programmed into an application program, or a set of instructions, that can be executed on a computing device. In some cases, the application program can be executed on a mobile computing device and the audio/video capture, analysis, scoring, recommendations, training exercises, and other feedback can be performed with the mobile computing device. In some cases, the system receives video and/or audio from multiple video capture devices capturing different views of the same shooter. The system may use the multiple, different views of the shooter in the analysis and feedback to the shooter for improving performance.

As shown in FIG. 12A, the system, running as an application on a mobile computing device 1200, captures video frames of a shooter 1202, establishes body landmarks to track over time, creates a wire frame model of the shooter 1203, tracks shots fired 1204 and provides feedback to the shooter 1202. As illustrated, the system may identify the stance of the shooter, “Weaver” stance in the illustrated example, tracks the number of shots 1204, and provides feedback 1206 on each shot. For instance, a shot taken at 7 seconds after beginning the string shows a hit at center of mass. The system identifies a reloading operation 1208 at 8 seconds that lasts 1.2 seconds, followed by a shot at 11 seconds showing that the shooter anticipated the recoil, and the shot was off center. In some cases, this functionality of the system may be viewed as a drill instructor that tracks the shots, provides feedback, and offers suggestions for improving posture, grip, stance, trigger pull, and the like, to improve shooter performance.

FIG. 12B illustrates an additional screen 1210 that may be displayed by the system in a Spotter modality in which the mobile computing device may have its video capture device pointed at the target. In some cases, the mobile computing device may use an internal or external lens to get a better view of the target and the mobile computing device may be coupled to a spotting scope or other type of optical or electronic telephoto zoom lens in order to get a better image of the target.

The system may be toggled between the different modes, such as Spotter, Drill Instructor, DOPE, Locker (in which information about the different firearms owned by the shooter may be stored), and program settings. The Spotter mode may show an additional screen 1210 with a view of the target upon which target hits may be visible. The system may also display other information, such as the firearm 1212a and ammunition 1212b combination being fired, the distance to the target 1214, the type of target 1216, the time of the shooting string 1218, the number of shots fired, the number of target hits 1220, and the score 1222, among other things. It may also show an image of the target 1224 and may further highlight the hits 1226 on the image of the target 1224. It should be appreciated that the Spotter mode may show the information, including the time elapsed, hits, score, and number of shots in real time. In addition, the system may also store the data associated with a shooting string for later playback, review, and analysis. For instance, the Drill Instructor mode may review the DOPE associated with a shooter and firearm and ammunition combination and provide a detailed analysis of mistakes the shooter makes with the particular firearm and offer exercise or suggestions to ameliorate the mistakes in order to improve shooter performance.

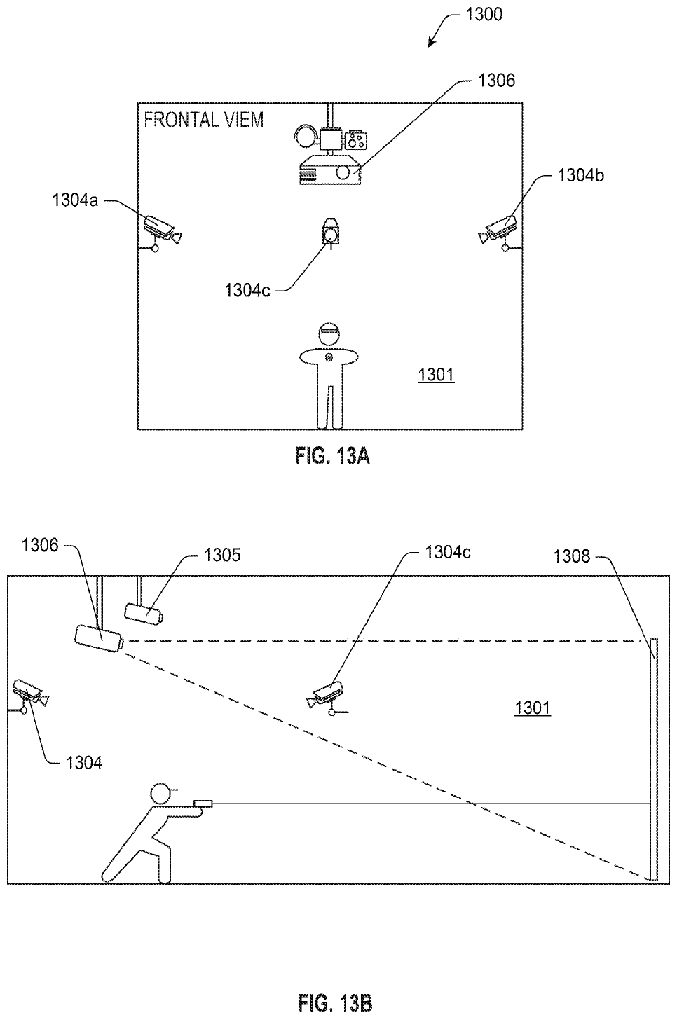

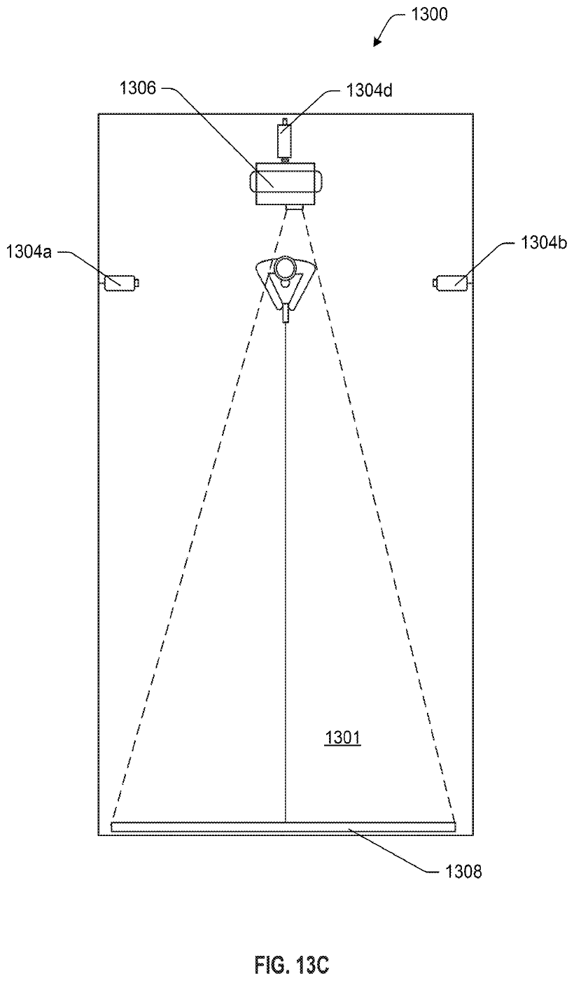

With reference to FIGS. 13A, 13B, and 13C, an example architecture for data capture 1300 is illustrated. According to some embodiments, a shooting range 1301 may be outfitted with one or more sensors, such as image sensors, projectors, and computing devices. FIG. 13A illustrates a shooting range 1301 looking down range from the perspective of the shooter 1302. FIG. 13B illustrates a shooting range 1301 from a side view, and FIG. 13C illustrates a shooting range 1301 from a top plan view.

One or more cameras 1304 may be mounted within the shooting range to capture video of the shooter which may be from multiple angles. The cameras 1304 may be any suitable type of video capture device, including without limitation, CCD cameras, thermal cameras, dual thermal cameras 1305 (e.g., a capture device having both thermal and optical capture capabilities), among others. The cameras 1304 may be mounted at any suitable location within the range, such as, for example, to the sides of the shooter 1304a, 1304b, facing the front of the shooter 1304c, overhead 1304d, among others.

In some cases, the cameras 1304 may be mounted to a gantry system that provides a portable structure for supporting the one or cameras 1304 to capture multiple angles of the shooter.

In some embodiments, a projector 1306 may be provided to project an image onto a screen 1308. In some cases, the projector may project any target image onto the screen or onto a shooting wall, and a shooter can practice dry firing (e.g., without firing live ammunition) and the system can register hits on the projected image. For example, an image may show a target on the screen and a shooter may dry fire at the target. The system can register the point of aim at the time of trigger pull and display the hit onto the projected target image. There are compatible devices that fire a laser through the barrel of the firearm when the trigger is pulled to indicate where a shot would have impacted the target. The thermal imaging camera 1304 may detect the laser hit location and the system may be configured to display the hit on the projected target and the system may further register and score the hit. In this way, shooters can practice using a shooting simulator using their own firearm without the need to travel to a dedicated shooting range. The system may recommend dry firing practice to ameliorate bad shooting habits.

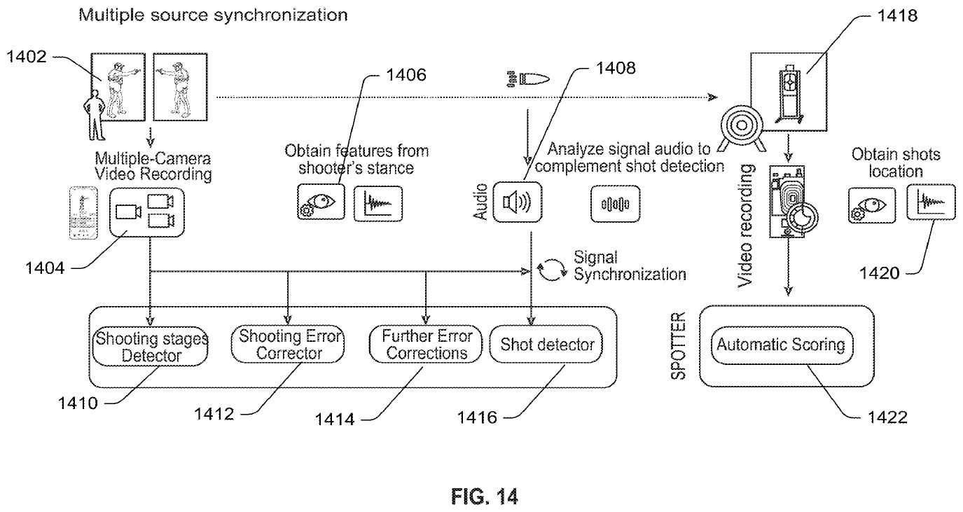

FIG. 14 illustrates the system configured with multiple source synchronization. In some embodiments, a shooter 1402 is captured with multiple video capture devices 1404 from different angles. The system obtains features from the shooter 1406, such as stance, pose, and motion. The system may analyze the captured audio signal 1408 to complement video shot detection. That is, the system may analyze both video and audio to detect a shot fired by the shooter, such as by correlating a spike in an audio waveform with a sudden muzzle raise of the firearm.

The system may be configured to detect shooting stages 1410, such as a first shooting string, reloading, second shooting string, including shots fired detection. The system may additional identify and determine shooting errors 1412 and identify the errors as well as drills and exercises to address the shooting errors. The error detection may be iterated and further error corrections 1414 may be proposed. The system may also incorporate shot detection 1416, as described herein, including correlation of shot detection with audio data.

The system may further capture images 1418, such as video images, of the target and register hits on the target, which may be correlated with motion data before and during the trigger pull. As described herein, the system may determine the shot location 1420, and ultimately determine a score 1422 for one or more of the shots fired. Some embodiments of the system thus provide an intelligent tutoring/adaptive training solution that turns the time-intensive and non-scalable live training environment into an automated and adaptive virtual scenario-based training solution.

According to some embodiments, the model is based on instructions that are executed by one or more processors that cause the processors to perform various acts. For example, the method may include collecting (as many as possible) pose analysis files, which may be stored as a comma separated value (CSV) file.

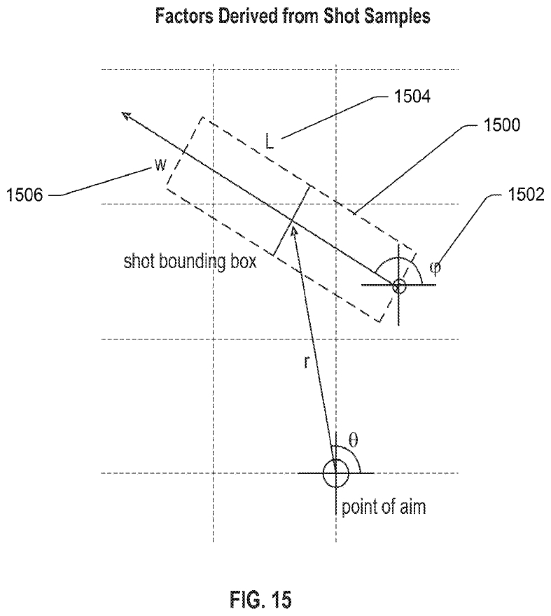

FIG. 15 illustrates a shot bounding box 1500 being determined by the system. A “drillparser.py” script may be configured to combine the pose analysis files. The system may then find the shots in the CSV files, such as for each of the 17 pose landmarks and the shots derive an oriented bounded box 1500 around the x-y coordinates for the 1.0 second time window up-to and including the shot, then used the angle φ 1502 and dimensions l 1504 and w 1506 of the bounding box 1500 as factors in a decision tree models for the score. The “allshots” approach processes data on a CSV file basis, so a bounding box 1500 is drawn around all the shots, as one row in the resulting dataset. The “oneshot” and “oneshotd” approach may handle each shot individually, so the shot bounding box 1500 may be an infinitesimal box around single shot so each row in the dataset is one shot. The “oneshotd” approach additionally orients the direction of bounding boxes around the 17 pose landmarks in time order while the “oneshot” approach ignores time.

The system thus is able to derive an oriented bounded box around each shot which may be oriented the direction of the box around the body landmarks.
3) These datasets are handled in BigML as:
1. Uploaded to BigML as Source objects
2. Source objects are converted to Dataset objects
3. Dataset objects are split into Training (80%)/Test (20%) datasets.
4. Tree Models are built using selected factors from the Training datasets
5. BatchPredictions are created using the appropriate Model and Test Datasets
6. Models are download as JSON PML objects for the next steps
4) The “modelannotator.py” script annotates the model PML files as needed for the explanation operation. In some cases, this annotation consists solely of adding a “targets” attribute to each node that is a list of all of the target (score) values reachable in the tree from that node.
5) The “itemexplainer.py” script uses a (virtual) pruned annotated model to “explain” which pose elements for a new drill result in prediction of an unsatisfactory score.
6) Of course, instances for which the predicted score differs significantly from the actual score can be used to adjust the model by repeating the model training through machine learning.

Factors derived from shot samples may include one or more of the following factors: shot_phi with a bounding box rotation (−π≤φ≤π), shot_l—bounding box length; shot_w—bounding box width; shot_lw—bounding box area; shot theta—bounding box center rotation (−π≤φ≤π); shot_r—bounding box center radius. The bounding box 1500 is drawn around the shot samples.

A very similar approach can be used to derive factors from body landmark samples. As the body landmarks move over time, each body landmark can likewise be used to create a bounding box with length, width, area, and rotation and correlated to the shot factors.

In some cases, the system is configured to use one or more cameras for machine vision of a shooter, determine one or more body landmarks (in some cases up to 17 or more body landmarks) and track the movement of each of these landmarks over time during a shooting drill. The system can correlate the time-bound body landmark movement with a scored shot and determine if the shot is good or bad. A good shot may be relative to the DOPE for the shooter, firearm, and ammunition combination. For example, where a single shot is closer to the aiming point than an average shot for the shooter, this may be categorized as a good shot. Furthermore, by looking at several shots over time, the system can correlate shooter behaviors with good or bad shots. Furthermore, by analyzing the shooter behaviors (e.g., body landmark motion), the system can predict whether a shot is a good shot or a bad shot without even seeing the target results. For example, a good shot may be considered a shot within the 9 or 10 ring of a target, while a bad shot may be any shot outside the 9 ring. Depending on the expertise of the marksman, the definition of good shot and bad shot may be varied. As an example, for a very skilled shooter, anything outside the 10 ring may be considered a bad shot.

Finally, by correlating the shooter behavior with the target accuracy, the system is able to provide an output to the shooter on the behavior that causes reduced accuracy. Moreover, the system my recommend one or more specific drills to the shooter to address the behavior that causes reduced accuracy.

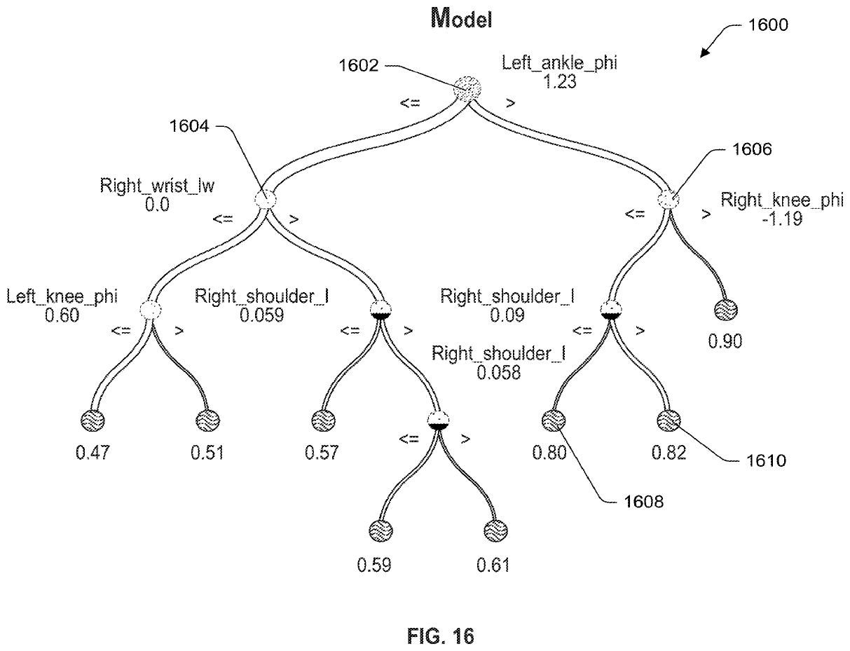

FIG. 16 illustrates some embodiments of a decision tree model 1600 for correlating body landmark factors with shot samples. A decision tree algorithm is a machine learning algorithm that uses a decision tree to make predictions. It follows a tree-like model of decisions and their possible consequences. In some cases, the algorithm works by recursively splitting the data into subsets based on the most significant feature at each node of the tree.

From the body landmark data, various features are extracted to represent the kinematic properties of body movements. These features encompass body landmark positions over time, a bounding box describing the movement of the body landmark during a time prior to and including the shot fired, relative distances between landmarks, and temporal derivatives, which capture dynamic aspects of motion. To facilitate model convergence, feature scaling is carried out.

The decision tree, depicted in FIG. 16, serves as the core of the model in some embodiments. It is selected for its ability to elucidate complex, non-linear relationships within the data while maintaining interpretability. The tree's depth is optimized to minimize overfitting through techniques like cross-validation or a predetermined maximum depth. The choice of splitting criteria, whether based on Gini impurity or information gain, depends on the specific problem. Pruning methods, such as enforcing a minimum number of samples per leaf, are applied to control excessive branching.

Training of the model may involve the recursive construction of the decision tree. The tree has nodes that correlate with the body landmarks. For example, a left_ankle_phi node 1602 may branch into a right_wrist_lw node 1604 and a right_knee_phi node 1606 and these branches can show how the bounding box rotation of the right ankle motion data affects the resulting shot placement in combination with the bounding box area of the right wrist or a rotation of the bounding box associated with the right knee. Similarly, the decision tree can correlate a shot placement with a combination of features. At each node, the training data is partitioned based on feature values, optimizing the chosen loss function, such as mean squared error or cross-entropy. Hyperparameters can be fine-tuned via cross-validation, and the model's performance is assessed using various metrics.

During real-time operation, the decision tree model continuously updates as new body landmark data becomes available for each shot fired. For each input feature vector derived from the live landmark data, the model traverses the decision tree, reaching a leaf node. The label assigned to the leaf node (indicating a positive or negative outcome) is utilized as the model's prediction. In the illustrated example, a right shoulder bounding box length between the values of 0.80 and 0.82 is consistent with a predicted result of the shooter's performance, shown at leaf nodes 1608 and 1610.

In the context of this model, positive outcomes signify successful execution of specific movements or achievement of desired shot placement. Conversely, negative outcomes denote incorrect movements, deviations from desired postures, or off-center shot placement.

The model's performance is rigorously assessed through metrics including but not limited to accuracy, precision, recall, F1-score, and area under the receiver operating characteristic (ROC) curve. Confusion matrices are employed to quantify the model's proficiency in classifying positive and negative outcomes.

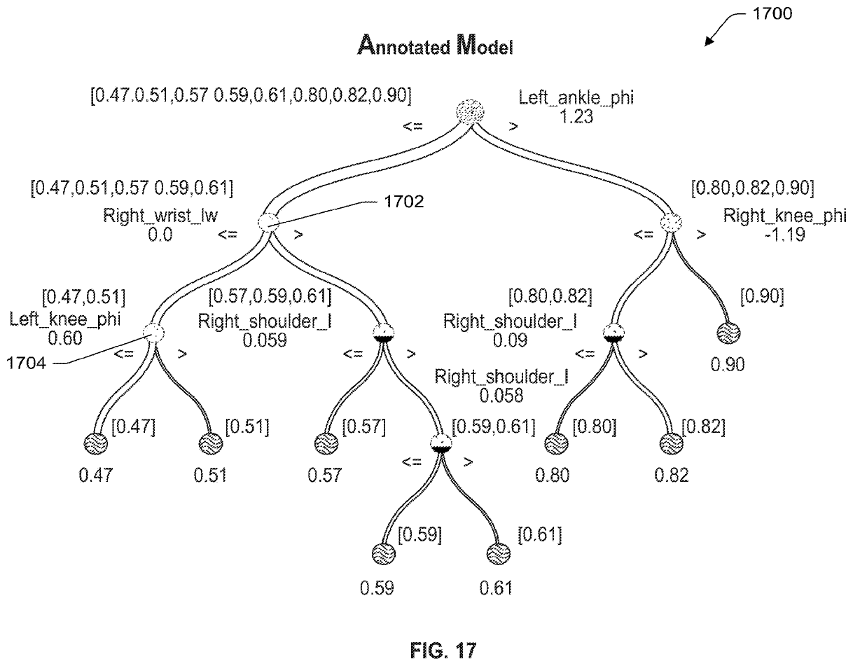

FIG. 17 illustrates an annotated model 1700 showing various values at several of the nodes. For example, during a shooting string, the area of the bounding box for the right wrist 1702 indicates values of 0.47, 0.51, 0.57, 0.59, and 0.61. This indicates that during the shooting string in which shots were being fired, the shooter moved her right wrist within an area defined by the displayed values. Following the branch below the right wrist 1702, for values that were below the average of the values, the system identifies that the left knee 1704 moved in a certain pattern, which can be correlated with either good shots or bad shots to look for a causality between the movement of the right wrist in combination with movement of the left knee. Other features can be similarly annotated within the model. The annotated features can be stored in a feature vector and corelated with each shot fired for analysis on how the different features combine to result in a particular shot performance.

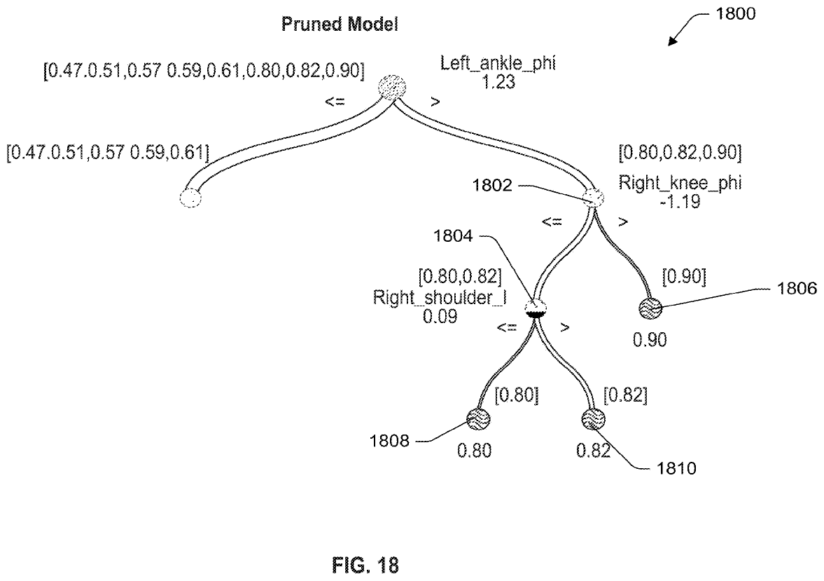

FIG. 18 illustrates a pruned model 1800 which allows a deeper dive into various features and their interrelation with one another. For example, when reviewing the feature of the right_knee_phi 1802 (e.g., the rotation of the bounding box associated with movement of the right knee during a shooting string), we can see values of 0.8, 0.82, and 0.9. Given these values, we can see that the right_knee_phi value of 0.9 provides one result at a first result node 1806. Where the right_knee_phi 1802 is 0.8 or 0.82 and the right_shoulder_l bounding box length 1804 is 0.09, we see second results at a second result node 1808 and a third result node 1810. In some cases, the second result node 1808 is associate with a bad shooting performance while the third node 1810 is associated with a good shooting performance. These non-linear causal relationships can be determined by the machine learning model, such that the system, by executing one or more machine learning algorithms, can determine which motions lead to better shooting results on poorer shooting results.

In some cases, isolation forests encode a dataset of trees such that leaf instances for each leaf are identical. Node splits may be chosen randomly rather than to reduce impurity of the child target values. In some cases, nodes are leaves when the training instances at the node have the same target value. In some instances, rare instances in the training dataset reaches a leaf earlier than less rare instances. According to some embodiments, new anomalous instances have short paths relative to tree depth for all trees in forest, which makes identifying anomalies more efficient.

In some cases, a classification and regression tree (CART) is a predictive model which explains how an outcome variable can be predicted based on other values. A CART-style decision tree is one where each fork is a split in a predictor variable and each end node contains a prediction for the outcome variable. It builds a binary tree to partition the feature space into segments that are homogeneous with respect to the target variable and is a recursive algorithm that makes binary splits on the input features based on specific criteria, creating a tree-like structure. CART-style decision trees may be useful in predicting an outcome of the shot based upon the motion data of one or more body landmarks. CART-style decision trees are multi-category classifiers (e.g., N>1), while isolation trees are single category classifiers (e.g., “anomalous or not”). In some cases, the CART-style decision trees can be reduced to isolation trees by designating M<N categories as “not-anomalous,” N−M as “anomalous” and pruning the branches that go to leaves with the N−M “anomalous” to their root node. This may be analogous to training an isolation tree on just the M<N “not-anomalous” instances, which allows impurity reducing splits and impure “not-anomalous” leaves.

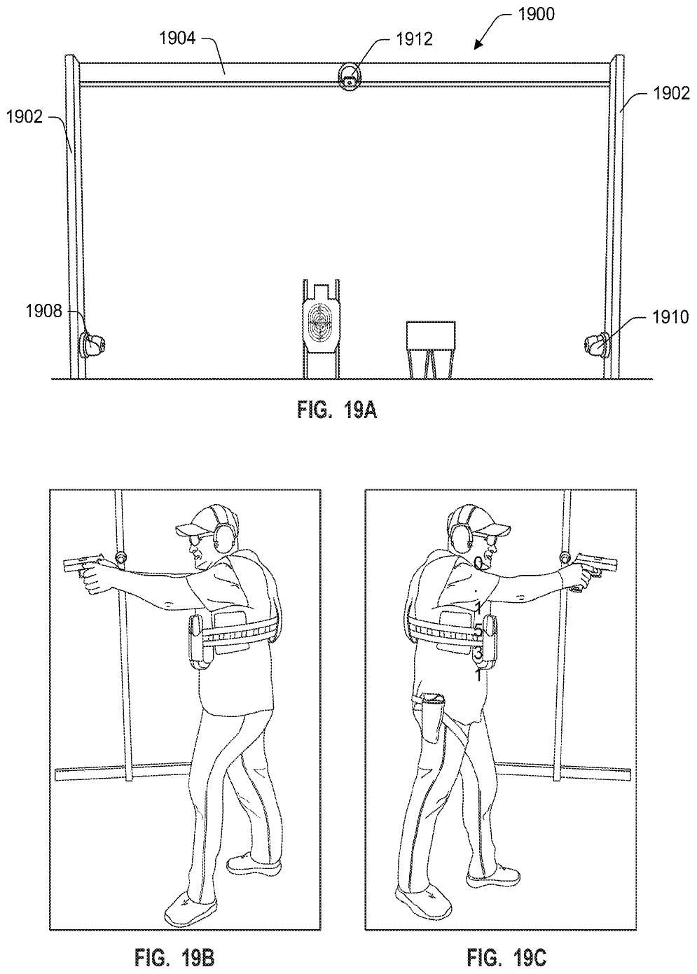

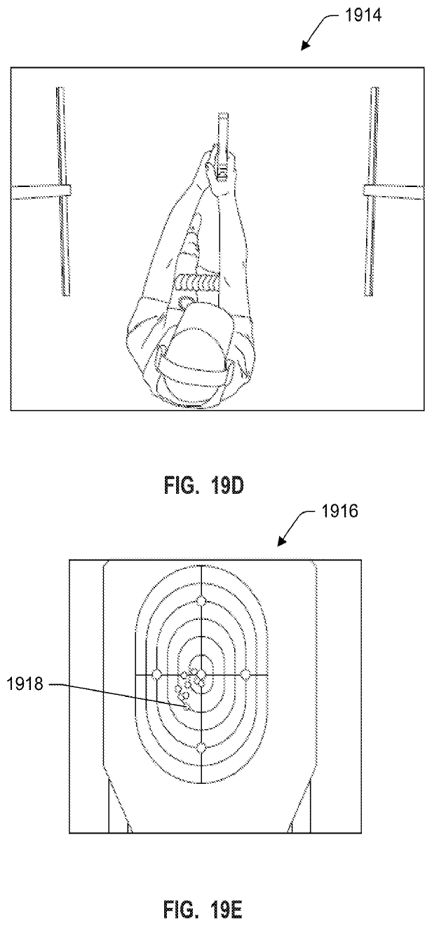

FIG. 19A illustrates a gantry 1900 system that may provide a portable mounting structure for accommodating one or more imaging devices, including one or more video cameras. In some cases, the structure includes one or more upright posts 1902 and one or more cross bars 1904. The gantry structure 1900 may be placed around the shooter, and in some cases, down-range of the shooter. For instance, the gantry 1900 may position the cross bar 1904 at a location that is about one foot (≈3 m) to 8 feet (≈2.4 m) above the shooter and between one foot (≈3 m) and 15 feet (≈4.5 m) in front of the shooter. In some examples, cameras are positioned on each upright and on the cross bar. Therefore, in some embodiments, two, three, or more cameras are positioned on the gantry with some of the cameras aimed at the shooter and one or more cameras may additionally be aimed down range at the target.

FIGS. 19B, 19C, and 19D illustrate various views captured by the cameras mounted to the gantry 1900. A first camera 1908 may be mounted to the cross bar 1904 or the upright 1902 and is positioned to capture a left-side view (FIG. 19B) of the shooter. The camera may be configured to capture the entire shooter's body, or may be configured to capture the shooter's upper body and head.

A second camera 1910 may be mounted on the cross bar 1904 or the upright 1902 and configured to capture a right-side view (FIG. 19C) of the shooter. The camera may be configured to capture the entire shooter's body, or may be configured to capture the shooter's upper body and head. In some cases, the first camera 1908 and the second camera 1910 utilize different fields of view, such that one of the cameras captures the entire body of the shooter, while the other one of the cameras only captures a portion of the shooter's body.

A third camera 1912 may be positioned on the cross bar 1904 and configured to capture an overhead view 1914 (FIG. 19D) of the shooter. By positioning camera to capture the shooter's motion from various angles, the system can correlate the video data from each camera and determine 3-dimensional motion data of the selected body landmarks.

A fourth camera may be located to capture video data of the target 1916 (FIG. 19E) and the target impacts 1918. The video data from each of the cameras can be synchronized and analyzed to determine when a shot is fired and to correlate a shot being fired with a registered hit or a miss on the target.

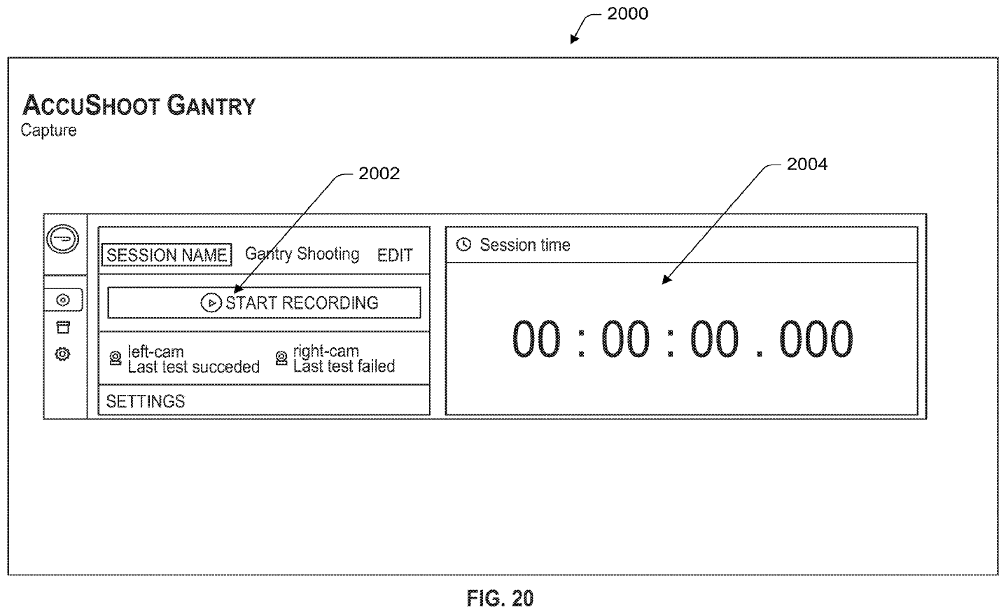

FIG. 20 illustrates a computer program user interface 2000 that can be used with the system and methods described herein. For instance, a computer program may be configured to receive the video data from the one or more cameras, synchronize the video data, determine when shots are fired, and register and score hits or misses on the target. The user interface 2000 may include a start recording button 2002 that allows the shooter to start the video capture. In some cases, a shooting string may be times, and the start recoding button may additionally start a timer. The user interface may further include a timer 2004 associated with the session. The user interface may be presented on a mobile computing device associated with the user, or on a mobile computing device associated with a facility. For example, a gantry system may be set up at a facility and a computing device associated with the facility may be connected to the gantry system and configured to receive the video data and provide the performance feedback of the embodiments described herein.

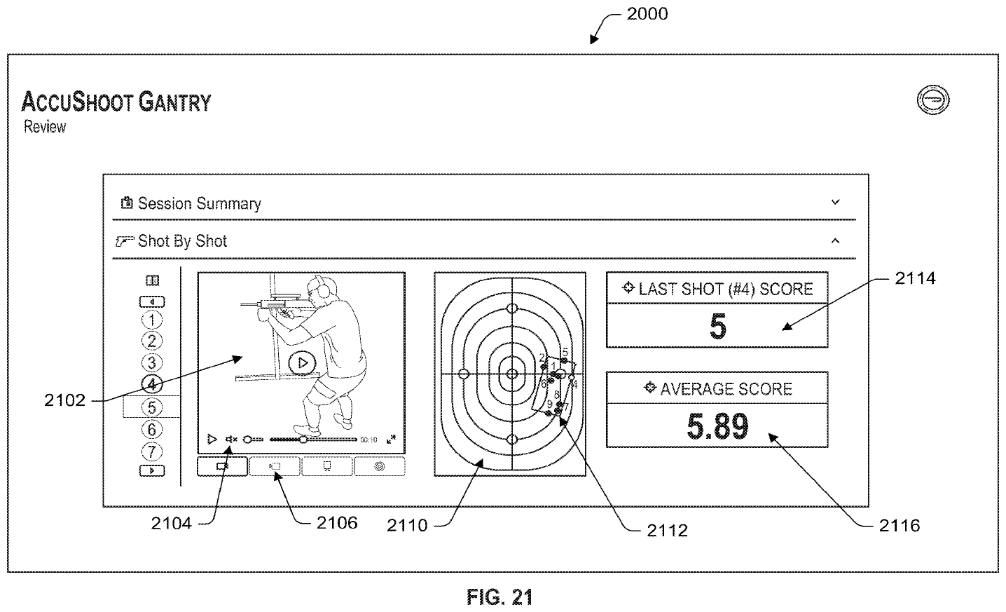

The user interface may be provided on any suitable display, such as a television, a touch-screen display, a tablet screen, a smart phone screen, or any other visual computer interface. With additional reference to FIG. 21, the user interface 2000 may display indicia associated with a shooting string, such as, for example, a video of the shooting string and motion during the shooting string 2102. The video may be displayed in a playback window and offers controls 2104 for playing, pausing, adjusting volume, and scrubbing through the video. In addition, there may be controls for selecting different views 2106, that is, controls allow the viewer to select video clips captured by different cameras during the shooting string, and may allow the view to watch different views of the shooting string, either individually or in a combined view, such as a side by side view. The views may be synchronized so the viewer can see different views of the same event at the same time.

The user interface 2000 may additionally show the target 2110 and may identify hits 2112 that the system registered on the target. The user interface 2000 may additionally display a score 2114 of the most recent shot along with an average score 2116 for the string. Of course, other information may be displayed, as desired by the user, which may include the training tips, the motion data that lead to an off-center shot, or other mistake during the shooting string.

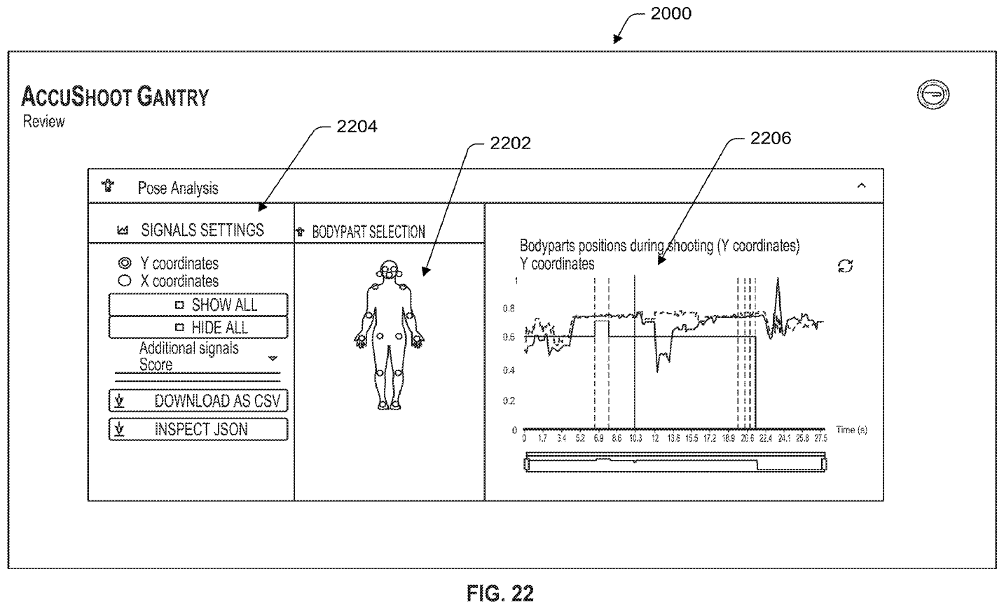

FIG. 22 illustrates additional view of the user interface 2000 in which a user can specify a body landmark selection 2202. In addition, the user interface 2000 provides a selection for signal setting 2204, which allows a user to specify details of Y coordinate motion or X coordinate motion. The user interface 2000, in response to the user selection, may display the motion data 2206 associated with the selection. This type of review and analysis allows a shooter to very specifically view the motion of individual body landmarks during a shooting string, and in addition, can specifically view horizontal movement, vertical movement, or both for review.

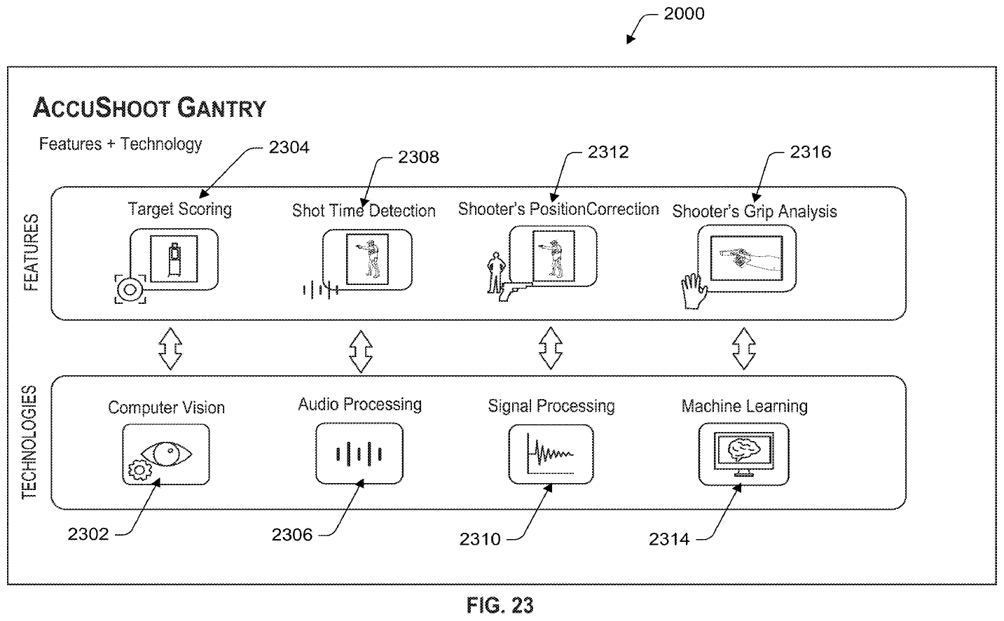

FIG. 23 illustrates some of the features and technologies employed by embodiments of the described systems and methods. In many embodiments, the disclosed system utilizes machine vision (e.g., computer vision) 2302 to track body landmarks of a participant (e.g., shooter), and also tracks changes to a target to provide automated target scoring 2304. Systems and methods may also utilize audio processing 2306 to enable shot time detection 2308, which may also be combined with computer vision techniques. The disclosed systems and methods may also utilize signal processing 2310 to provide for shooter's position correction 2312, including pose, posture, motion, grip, trigger pull, and others. Systems and methods described herein also apply machine learning 2314 in order to determine causality for off-center shots, which may include analyses on the shooter's pose, grip 2316, trigger pull, stance, body landmark motion, among others.

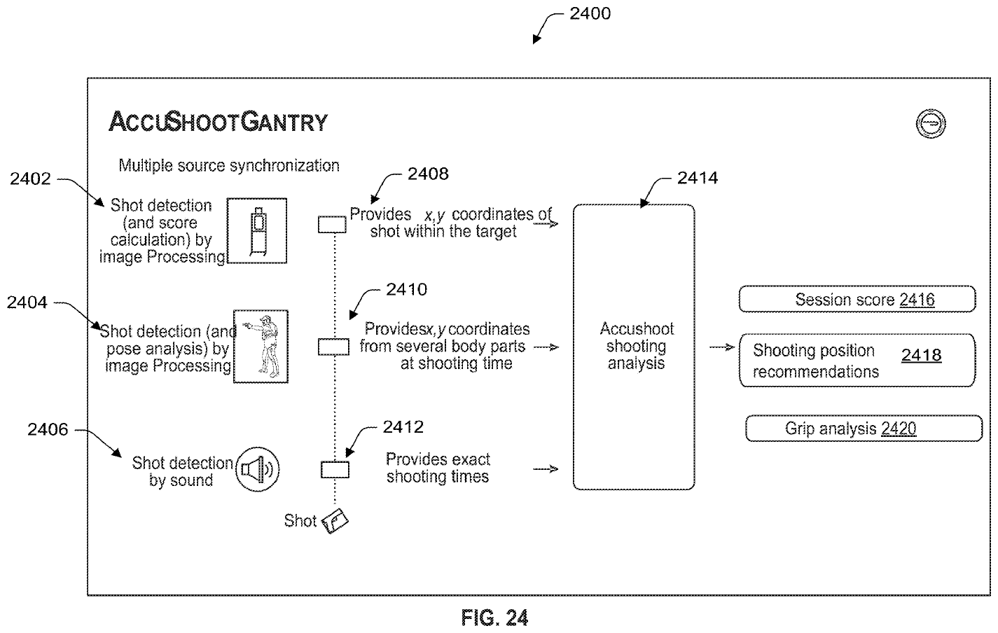

FIG. 24 illustrates a method 2400 according to embodiments described herein. The system may receive video data and optionally audio data. The system may be configured to detect shots 2402 and score through image processing on video data of a target. The system may process video data to determine shots fired and pose analysis of a shooter 2404. In addition, the system may analyze audio data for shot detection 2406.

The shot detection 2402 provides coordinates (e.g., x, y coordinates) of shots within the target 2408. The pose analysis of the shooter 2404 provides coordinates (e.g., x, y, and optionally z coordinates) of body landmarks during the shooting process 2410. The audio shot detection 2406 provides an exact time of a shot 2412. The shooting analysis may include one or more machine learning algorithms that receive the shot and body data, and through machine learning algorithms, detects and predicts cause and effect for the shot performance of the shooter with the firearm and ammunition combination, which may be referred to as conducting a shoot analysis 2414. For example, embodiments of the system may generate one or more of a session score 2416, shooting position recommendations 2418, shooting mistakes, and grip analysis 2420, among others.

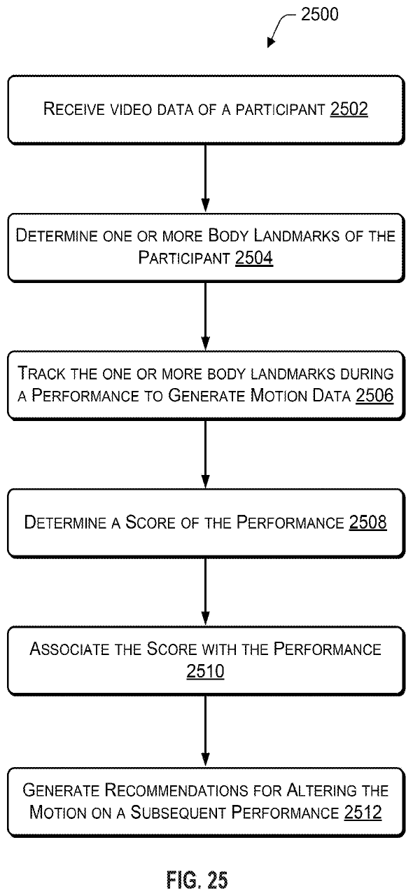

FIG. 25 illustrates a sample process 2500 flow for using machine vision and machine learning to track body landmarks of a participant and generate recommendations for improvement. As discussed herein, the systems and methods described herein can be used for any event, such as a sporting event, that benefits from repeatability and accurate body kinematics. Some such events include, in addition to shooting, archery, golf, bowling, darts, running, swimming, pole vaulting, football, baseball, basketball, hockey, and many other types of sports. In any event, the system is configured to track body landmarks of a participant and determine ways to alter the body motion to improve performance.

At block 2502, the system receives video data of a participant. This may come from a single image capture device, or two image capture devices, or three or more image capture devices. An image capture device may be any suitable imaging device that is configured to capture sequential images of a participant and may include any consumer-grade or professional grade video camera, including cameras regularly incorporated into mobile computing devices.

At block 2504, the system determines one or more body landmarks of the participant. The body landmarks may be associated with any joint, body part, limb, or a location associated with a joint, limb, or body part. In some cases, the system generates a wireframe based on the one or more body landmarks and may use less than all of the body landmarks in generating the wireframe model.

At block 2506, the body landmarks are tracked during performance of an activity to generate motion data. As a non-limiting example, body landmarks may be created for the hands, wrists, arms, head, shoulders, torso, waist, knees, ankles, and feet of a golfer which may be tracked during a swing of a golf club.

At block 2508, a score is determined and associated with the performance. As described, in an activity involving a projectile, the score may be associated with the path or destination of the projectile. In golf, for example, the score may be based on the distance, direction, nearness to a target, or a metric associated with an average or a past performance of the participant. In short, any metric may be used to evaluate the quality of the outcome of the performance.

At block 2510, the score is associated with the performance. That is, a connection is made between the performance and the determined score, which may be stored for later analysis and to determine trends in performance over time, or to compare one performer with another.

At block 2512, the system generates recommendations for altering the motion on a subsequent performance to improve the outcome. In some cases, the recommendation may involve the hands, including a grip on a firearm, golf club, bat, stick, and the like. The recommendations may also include a change is weight distribution or transfer. The recommendations may include the motion of the hands, head, shoulders, body, legs, feet, or other body part. In many cases, the recommendations include suggestions for altering the motion of the one or more body landmarks in an effort to improve the score of the performance in a subsequent try.

As described above, in some embodiments, the system utilizes a gantry type arrangement in which a plurality of recording devices may be used to capture audio and video of the participant and/or the target. In some cases, an imaging device can be pointed at the target, which may have a zoom lens, digital zoom feature or rely on an external lens, such as a camera mounted to a spotting scope for capturing images of a target located down range. In some cases, the system is configured to synchronize multiple sources, such as one or more video frames, and/or audio data from one or more audio capture devices. In some cases, the system is configured to synchronize multiple video frames and audio data from one or more audio/video capture devices.

The system may utilize one or more machine learning models for synchronization, prediction, verification, and may further be trained to analyze scoring data and associate the scoring data with the motion data to determine correlations between specific motion data (e.g., behaviors) and scoring trends. As an example, the system may correlate that a shooter's wrist pivots downwardly before shots that typically score outside and below the 10 ring and determine that the shooter is anticipating the firearm recoil before the shot. The system may then provide feedback to the user with not only information related to the motion/score correlation but may also provide one or more exercises or drills to allow the user to recognize and address the behavior resulting in the reduced score. A similar process may be used with any motion data from any activity or sport, as described elsewhere herein.

In some embodiments that utilize multiple video capture devices, the system may track body motion in two or three dimensions and from multiple angles. The two- or three-dimensional body motion data may be correlated, synchronized, and analyzed to determine two- or three-dimensional motion data, which can be further correlated with a resulting score.

While embodiments of the described system are described in relation to a shooter firing a string of shots, it should be understood that the systems and methods described herein are applicable to capturing any type of body motion and applicable to other sports where body motion may lead to performance. For example, embodiments of the systems described herein may be used to track, critique, and improve body motion such as basketball free throw shooting, golf swings, figure skating elements, archery, soccer, baseball swing, or any other sport or motion where the movements of a set of observable body landmarks can be recorded in time and there is some observed causal consequence of the movement.

The system may include one or more processors and one or more computer readable media that may store various modules, applications, programs, or other data. The computer-readable media may include instructions that, when executed by the one or more processors, cause the processors to perform the operations described herein for the system.

In some implementations, the processor(s) may include a central processing unit (CPU), a graphical processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program modules, program data, and/or one or more operating systems. The one or more control systems, computer controller and remote control, may include one or more cores.

Embodiments may be provided as a computer program product including a non-transitory machine-readable storage medium having stored thereon instructions (in compressed or uncompressed form) that may be used to program a computer (or other electronic device) to perform processes or methods described herein. The computer-readable media may include volatile and/or nonvolatile memory, removable and non-removable media implemented in any method or technology for storage of information, such as computer-readable instructions, data structures, program modules, or other data. The machine-readable storage medium may include, but is not limited to, hard drives, floppy diskettes, optical disks, CD-ROMs, DVDs, read-only memories (ROMs), random access memories (RAMs), EPROMS, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the description do not preclude additional components and are to be construed as open ended.

The specification and annexed drawings disclose examples of systems, apparatus, devices, and techniques that may provide a system and method for determining acoustical signatures of discharged firearms. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed, and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What I claim is:

1. A method for improving shooting performance, comprising:
receiving video data of a shooter;
determining one or more body landmarks of the shooter;
tracking the one or more body landmarks during a shot to generate shot motion data;
determining a score of the shot;
associating the shot motion data with the score; and
generating recommendations for altering the motion data on a subsequent shot.

2. The method of claim 1, wherein determining one or more body landmarks of the shooter comprises generating a wire frame model by connecting the body landmarks.

3. The method of claim 1, wherein associating the shot motion data with the score comprises executing a classification and regression tree machine learning model to identify causal relationship between the shot motion data and the score.

4. The method of claim 1, further comprising determining, through image analysis of the video data of the shooter, a grip of the shooter.

5. The method of claim 4, further comprising analyzing the grip of the shooter and providing, on a display screen, grip recommendations to alter the grip.

6. The method of claim 1, wherein determining the score of the shot comprises:
receiving target video data;
performing image analysis on the received target video data;
determining a hit on the target; and
determining a score of the hit.

7. The method of claim 1, wherein receiving the video data includes capturing video data by a mobile phone.

8. The method of claim 1, wherein determining one or more body landmarks includes determining 17 body landmarks.

9. The method of claim 1, wherein tracking the one or more body landmarks includes generating a bounding box around each of the one or more body landmarks.

10. The method of claim 1, further comprising executing a machine learning model to correlate the shot motion data with the score.

11. The method of claim 10, wherein the machine learning model is configured to determine the motion data that results in an off-center target hit.

12. A method for improving a causal consequence of body movement, comprising:
receiving video data of a body motion;
determining one or more body landmarks viewable in the video data of the body motion;
tracking the one or more body landmarks during an action;
generating, based at least in part on the tracking the one or more body landmarks, motion data;
determining a score associated with the motion data;
associating the motion data with the score; and
generating recommendations for altering the motion data on a subsequent action.

13. The method of claim 12, wherein receiving the video data includes capturing the video data by a mobile computing device.

14. The method of claim 12, further comprising executing a machine learning model to correlate the motion data with the score.

15. The method of claim 14, wherein the machine learning model is configured to determine the motion data that results in a reduced score.

16. The method of claim 15, further comprising predicting, by the machine learning model, a predicted score based on the motion data.

17. The method of claim 16, further comprising comparing the predicted score with the score.
